(19) United States
(12) Patent Application Publication
(10) Pub. No.: US 2023/0354320 A1
(43) Pub. Date: Nov. 2, 2023

(54) LATENCY REDUCTION FOR TRANSMISSION OR RECEPTION OF DATA

(71) Applicant: Samsung Electronics Co., Ltd., Suwon-si (KR)

(72) Inventor: Aris Papasakellariou, Houston, TX (US)

(21) Appl. No.: 18/299,629

(22) Filed: Apr. 12, 2023

Related U.S. Application Data
(60) Provisional application No. 63/335,301, filed on Apr. 27, 2022.
(60) Provisional application No. 63/353,411, filed on Jun. 17, 2022.
(60) Provisional application No. 63/407,892, filed on Sep. 19, 2022.

(51) Int. Cl. H04W 72/1268; H04W 72/23; H04L 1/1812

(52) U.S. Cl. CPC H04W 72/1268; H04W 72/23; H04L 1/1812

(57) ABSTRACT

Apparatuses and methods for latency reduction for transmission or reception of data. A method performed by a user equipment (UE) includes receiving first information for a first configured grant (CG) configuration and second information for a second CG configuration. The method further includes determining: based on the first information, that scheduling by downlink control information (DCI) formats for physical uplink shared channels (PUSCHs) with transport blocks (TBs) associated with the first CG configuration is enabled; based on the second information, that scheduling by DCI formats for PUSCHs with TBs associated with the second CG configuration is disabled; to start a timer after a first CG-PUSCH transmission with a first TB associated with the first CG configuration; and to ignore the timer after a second CG-PUSCH transmission with a second TB associated with the second CG configuration. The method further includes transmitting a first PUSCH with the first TB.

### CROSS-REFERENCE TO RELATED APPLICATION AND CLAIM OF PRIORITY

This application claims priority under 35 U.S.C. § 119(e) to U.S. Provisional Patent Application No. 63/335,301 filed on Apr. 27, 2022, U.S. Provisional Patent Application No. 63/353,411 filed on Jun. 17, 2022, and U.S. Provisional Patent Application No. 63/407,892 filed on Sep. 19, 2022. The above-identified provisional patent applications are hereby incorporated by reference in their entirety.

### TECHNICAL FIELD

The present disclosure relates generally to wireless communication systems and, more specifically, to reducing latency and improving spectral efficiency for transmission of data from a user equipment (UE) to a base station.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for latency reduction for transmission or reception of data.

In one embodiment, a method performed by a UE is provided. The method includes receiving first information for a first configured grant (CG) configuration and second information for a second CG configuration. The method further includes determining: based on the first information, that scheduling by downlink control information (DCI) formats for physical uplink shared channels (PUSCHs) with transport blocks (TBs) associated with the first CG configuration is enabled; based on the second information, that scheduling by DCI formats for PUSCHs with TBs associated with the second CG configuration is disabled; to start a timer after a first CG-PUSCH transmission with a first TB associated with the first CG configuration; and to ignore the timer after a second CG-PUSCH transmission with a second TB associated with the second CG configuration. The method further includes transmitting a first PUSCH with the first TB. The first PUSCH is scheduled by a first DCI format.

In another embodiment, a UE is provided. The UE includes a transceiver configured to receive first information for a first CG configuration and second information for a second CG configuration. The UE further includes a processor operably coupled to the transceiver. The processor is configured to determine: based on the first information, that scheduling by DCI formats for PUSCHs with TBs associated with the first CG configuration is enabled; based on the second information, that scheduling by DCI formats for PUSCHs with TBs associated with the second CG configuration is disabled; to start a timer after a first CG-PUSCH transmission with a first TB associated with the first CG configuration; and to ignore the timer after a second CG-PUSCH transmission with a second TB associated with the second CG configuration. The transceiver is further configured to transmit a first PUSCH with the first TB. The first PUSCH is scheduled by a first DCI format.

In yet another embodiment, a base station is provided. The base station includes a transceiver configured to transmit first information for a first CG configuration and second information for a second CG configuration. The base station includes a processor, operably coupled to the transceiver. The processor is configured to determine: based on the first information, that scheduling by DCI formats for PUSCHs with TBs associated with the first CG configuration is enable; based on the second information, that scheduling by DCI formats for PUSCHs with TBs associated with the second CG configuration is disabled; to start a timer after a first CG-PUSCH transmission with a first TB associated with the first CG configuration; and to ignore the timer after a second CG-PUSCH transmission with a second TB associated with the second CG configuration. The transceiver is further configured to receive a first PUSCH with the first TB. The first PUSCH is scheduled by a first DCI format.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4 and 5 illustrate example wireless transmit and receive paths according to embodiments of the present disclosure;

FIG. 6 illustrates an example transmitter structure using orthogonal frequency-division multiplexing (OFDM) according to embodiments of the present disclosure;

FIG. 7 illustrates an example receiver structure using OFDM according to embodiments of the present disclosure;

FIG. 8 illustrates an example method for a UE to provide quantized buffer status report (BSR) information in a physical uplink control channel (PUCCH) transmission according to embodiments of the present disclosure;

FIG. 9 illustrates an example method for a UE to transmit a sounding reference signal (SRS) to indicate a positive scheduling request (SR) according to embodiments of the present disclosure;

FIG. 10 illustrates an example method for a UE to determine resources for a configured grant physical uplink shared channel (CG-PUSCH) transmission based on an indication of available resources by a downlink control information (DCI) format according to embodiments of the present disclosure;

FIG. 11 illustrates an example method for a UE to transmit a PUSCH, or receive a physical downlink shared channel (PDSCH), that includes code blocks (CBs) or code block groups (CBGs) with different modulation and coding scheme (MCS) according to embodiments of the present disclosure;

FIG. 12 illustrates an example method for a UE to transmit a PUSCH, or receive a PDSCH, that includes CBs or CBGs with different MCS according to embodiments of the present disclosure;

FIG. 13 illustrates an example method for a UE to report multiple channel quality indicator (CQI) values in a channel state information (CSI) report according to embodiments of the present disclosure;

FIG. 14 illustrates an example method for a UE to skip measurements according to embodiments of the present disclosure;

FIG. 15 illustrates an example method for indicating to a UE disabling of hybrid automatic repeat request (HARQ) retransmissions for a CG-PUSCH configuration by a parameter associated with the CG-PUSCH configuration according to embodiments of the present disclosure;

FIG. 16 illustrates an example method for indicating to a UE disabling of HARQ retransmissions for a CG-PUSCH configuration by a DCI format activating CG PUSCH transmissions for the CG-PUSCH configuration according to embodiments of the present disclosure;

FIG. 17 illustrates an example method for a UE to transmit a first PUSCH with an initial transmission of the transport block (TB) on a first carrier/cell and transmit a second PUSCH with a HARQ retransmission of the TB on a second carrier/cell according to embodiments of the present disclosure; and

FIG. 18 illustrates an example method for a UE to switch cells for CG-PUSCH transmissions of a CG-PUSCH configuration according to embodiments of the present disclosure.

### DETAILED DESCRIPTION

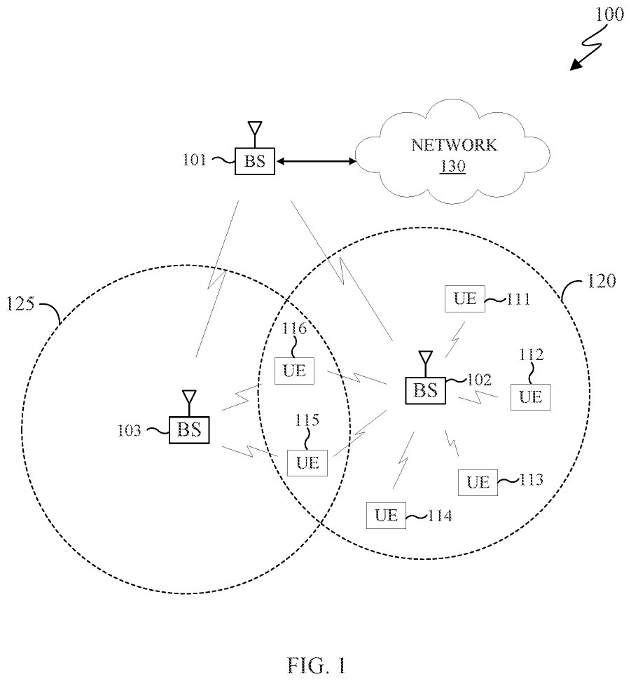

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.1.0, “NR; Physical channels and modulation;” 3GPP TS 38.212 v17.1.0, “E-UTRA, NR, Multiplexing and Channel coding”; 3GPP TS 38.213 v17.1.0; “NR, Physical Layer Procedures for Control”; 3GPP TS 38.214 v17.1.0; “NR, Physical Layer Procedures for Data”; 3GPP TS 38.321 v17.0.0, “NR; Medium Access Control (MAC) protocol specification”; 3GPP TS 38.331 v17.0.0, “NR; Radio Resource Control (RRC) Protocol Specification.”

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to this disclosure. The embodiment of the wireless network 100 shown in FIG. 1 is for illustration only. Other embodiments of the wireless network 100 can be used without departing from the scope of this disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, other well-known terms may be used instead of “gNodeB” or “gNB,” such as “base station” or “access point.” For the sake of convenience, the terms “gNodeB” and “gNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an gNB, whether the UE is a mobile device (such as a mobile telephone or smartphone) or is normally considered a stationary device (such as a desktop computer or vending machine). The UE may also be a car, a truck, a van, a drone, or any similar machine or a device in such machines.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115, the UE 116, UE 117 and UE 118. In some embodiments, one or more of the gNBs 101-103 may communicate with each other and with the UEs 111-118 using 5G, long-term evolution (LTE), LTE-A, WiMAX, or other advanced wireless communication techniques. In some embodiments, multiple UEs, e.g., UE 117, UE 118 and UE 119 may communicate directly with each other through device-2-device communication. In some embodiments, a UE, e.g., UE 119, is outside the coverage area of the network, but can communicate with other UEs inside the coverage area of the network, e.g., UE 118, or outside the coverage area of the network.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

As described in more detail below, one or more of the UEs 111-116 include circuitry, programing, or a combination thereof for supporting latency reduction for transmission or reception of data. In certain embodiments, one or more of the gNBs 101-103 include circuitry, programing, or a combination thereof for supporting latency reduction for transmission or reception of data.

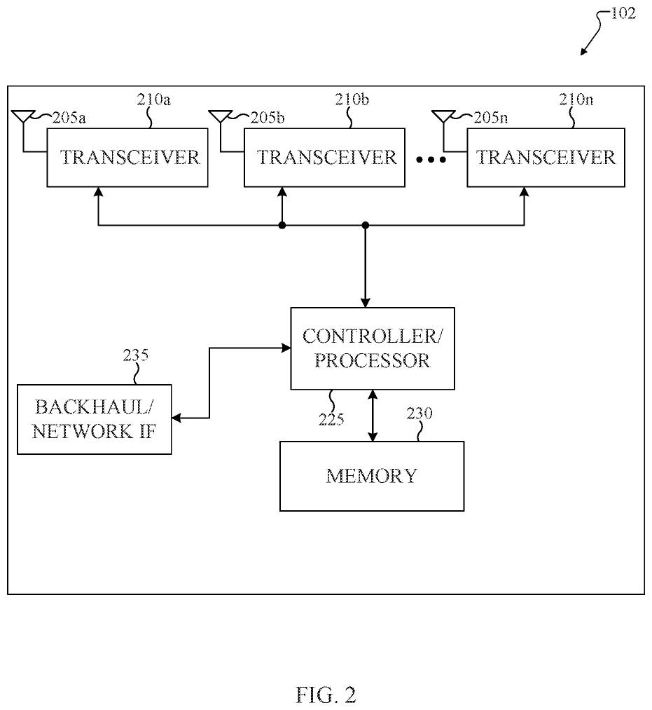

FIG. 2 illustrates an example gNB 102 according to this disclosure. The embodiment of the gNB 102 shown in FIG. 2 is for illustration only, and other gNBs of FIG. 1 can have the same or similar configuration. However, gNBs come in a wide variety of configurations, and FIG. 2 does not limit the scope of this disclosure to any particular implementation of an gNB. It is noted that gNB 101 and gNB 103 can include the same or similar structure as gNB 102.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting latency reduction for transmission or reception of data. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

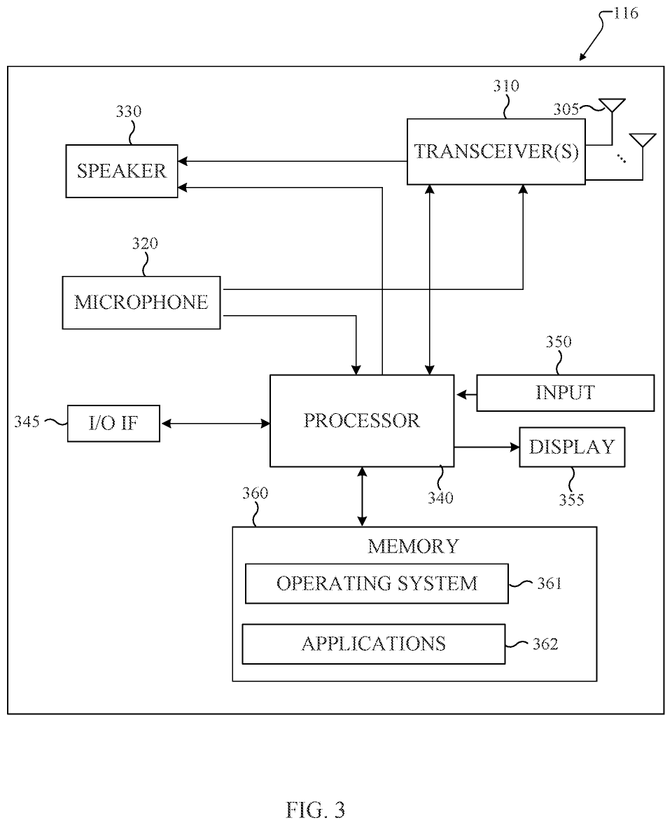

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for latency reduction for transmission or reception of data. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

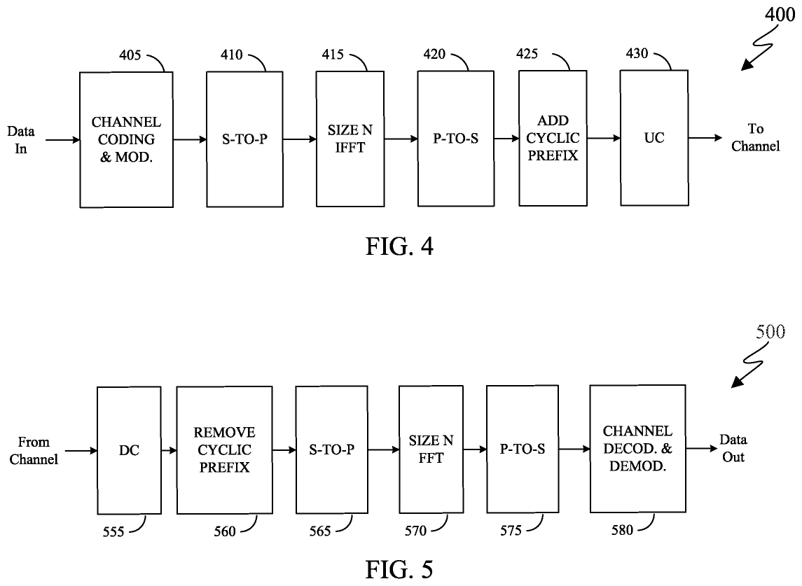

FIG. 4 and FIG. 5 illustrate example wireless transmit and receive paths according to this disclosure. In the following description, a transmit path 400, of FIG. 4, may be described as being implemented in a gNB (such as the gNB 102), while a receive path 500, of FIG. 5, may be described as being implemented in a UE (such as a UE 116). However, it may be understood that the receive path 500 can be implemented in a gNB and that the transmit path 400 can be implemented in a UE. Furthermore, it will be understood that the receive path 500 can be implemented in one UE, and that the transmit path 400 can be implemented in another UE in case of device-2-device communication. In some embodiments, the receive path 500 is configured to support latency reduction for transmission or reception of data as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the gNBs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A PDCCH transmission is over a number of control channel elements (CCEs) from a predetermined set of numbers of CCEs referred to as CCE aggregation level within a control resource set (CORESET).

A PDSCH transmission is scheduled by a DCI format or is semi-persistently scheduled (SPS) as configured by higher layers and activated by a DCI format. SPS PDSCH receptions can be according to one or more configurations for corresponding parameters that are provided by higher layers as described in TS 38.331 v17.0.0 “NR; Radio Resource Control (RRC) protocol specification”. A PDSCH reception by a UE provides one or more transport blocks (TBs), wherein a TB is associated with a hybrid automatic repeat request (HARQ) process that is indicated by a HARQ process number field in a DCI format scheduling the PDSCH reception or activating a SPS PDSCH reception. A TB transmission can be an initial one or a retransmission as identified by a new data indicator (NDI) field in the DCI format scheduling a PDSCH reception that provides a TB retransmission for a given HARQ process number.

A gNB transmits one or more of multiple types of RS including channel state information RS (CSI-RS) and demodulation RS (DMRS)—see also TS 38.211 v17.1.0 “NR; Physical channels and modulation”. A CSI-RS is primarily intended for UEs to perform measurements and provide channel state information (CSI) to a gNB. For channel measurement or for time tracking, non-zero power CSI-RS (NZP CSI-RS) resources are used. For interference measurement reports (IMRs), CSI interference measurement (CSI-IM) resources are used (see also TS 38.213 v17.1.0 “NR; Physical Layer Procedures for Control”). The CSI-IM resources can also be associated with a zero power CSI-RS (ZP CSI-RS) configuration. A UE can determine CSI-RS reception parameters through DL control signaling or higher layer signaling, such as radio resource control (RRC) signaling from a gNB (see also TS 38.331 v16.5.0 “NR; Radio Resource Control (RRC) Protocol Specification”). A DMRS is typically transmitted only within a BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access (see also TS 38.211 v17.1.0 “NR; Physical channels and modulation”). A UE transmits data information or UCI through a respective physical UL shared channel (PUSCH) or a physical UL control channel (PUCCH). A PUSCH or a PUCCH can be transmitted over a variable number of symbols in a slot including one symbol. When a UE simultaneously transmits data information and UCI, the UE can multiplex both in a PUSCH or, depending on a UE capability, transmit both a PUSCH with data information and a PUCCH with UCI at least when the transmissions are on different cells.

A PUSCH transmission can be scheduled by a DCI format or be configured by higher layers and is then referred as configured grant (CG) PUSCH. A UE can be provided with multiple configurations for CG-PUSCH transmissions, as described in TS 38.214 v17.1.0 “NR; Physical layer procedures for data” and can select a configuration according to characteristics for a CG-PUSCH transmission such as a transport block size or a latency requirement.

UCI includes hybrid automatic repeat request acknowledgement (HARQ-ACK) information, indicating correct or incorrect decoding of transport blocks (TBs) or of code block groups (CBGs) in a PDSCH, scheduling request (SR) indicating whether a UE has data in its buffer to transmit, and CSI reports enabling a gNB to select appropriate parameters for PDSCH/TB or PDCCH/DCI format transmissions to a UE. A UE transmits a PUCCH on a primary cell of a cell group. HARQ-ACK information is either a positive acknowledgement (ACK) when a TB decoding is correct or a negative acknowledgement (NACK) when a TB decoding is incorrect. An ACK can be represented by a binary ‘1’ value and a NACK can be represented by a binary ‘0’ value. A UE multiplexes HARQ-ACK information in a slot indicated by a value of PDSCH-to-HARQ_feedback timing indicator field in the DCI format, from a set of slot timing values K₁, or indicated by higher layers. The UE does not transmit more than one PUCCH with HARQ-ACK information in a slot unless the UE is configured transmissions to two transmission-reception points (TRPs) as identified by two respective values of 0 and 1 for a higher layer parameter CORESETPoolIndex associated with CORESETs where a UE receives PDCCH and a value of 0 is assumed for a CORESET when CORESETPoolIndex is not provided for the CORESET as described in TS 38.213 v17.1.0 “NR; Physical Layer Procedures for Control”.

A UE transmits a PUCCH with a (positive) SR using an unmodulated sequence over a number of symbols. Upon detection of the PUCCH, a gNB can determine that the UE has data to transmit and can then schedule a PUSCH for the UE to also provide a buffer status report (BSR) in order for the gNB to obtain information about the amount of data that the UE needs to provide. That procedure introduces additional latency in the UE providing the data, especially for unpaired spectrum operation (TDD), as the UE needs to transmit a PUSCH to provide a BSR prior to the gNB being able to schedule the UE with the required resources that the gNB can determine based on the BSR.

UL RS includes DMRS and SRS. DMRS is typically transmitted within a BW of a respective PUSCH or PUCCH. A gNB can use a DMRS to demodulate information in a respective PUSCH or PUCCH. SRS is transmitted by a UE to provide a gNB with an UL CSI and, for a TDD system, to also provide a PMI for DL transmission. Further, as part of a random access procedure or for other purposes, a UE can transmit a physical random access channel (PRACH).

DL receptions and UL transmissions by a UE can be configured to occur in a corresponding DL bandwidth part (BWP) and UL BWP. A DL/UL BWP is smaller than or equal to a DL/UL bandwidth of a serving cell. Multicast (or groupcast) PDSCH receptions can occur in a common frequency region for a group of UEs, wherein the common frequency region is within an active DL BWP for each UE from the group of UEs. DL transmissions from a gNB and UL transmissions from a UE can be based on an orthogonal frequency division multiplexing (OFDM) waveform including a variant using DFT preceding that is known as DFT-spread-OFDM (see also TS 38.211 v17.1.0 “NR; Physical channels and modulation”).

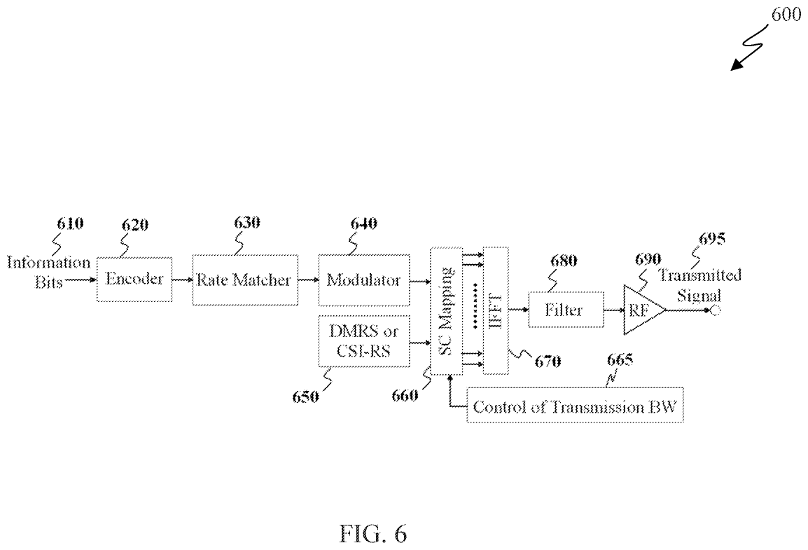

FIG. 6 illustrates an example transmitter structure using OFDM 600 according to embodiments of the present disclosure. The embodiment of the transmitter structure using OFDM 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the transmitter structure using OFDM 600.

As shown in FIG. 6, information bits, such as DCI bits or data bits 610, are encoded by encoder 620, rate matched to assigned time/frequency resources by rate matcher 630, and modulated by modulator 640. Subsequently, modulated encoded symbols and DMRS or CSI-RS 650 are mapped to SCs 660 by SC mapping unit 665, an inverse fast Fourier transform (IFFT) is performed by filter 670, a cyclic prefix (CP) is added by CP insertion unit 680, and a resulting signal is filtered by filter 690 and transmitted by a radio frequency (RF) unit 695.

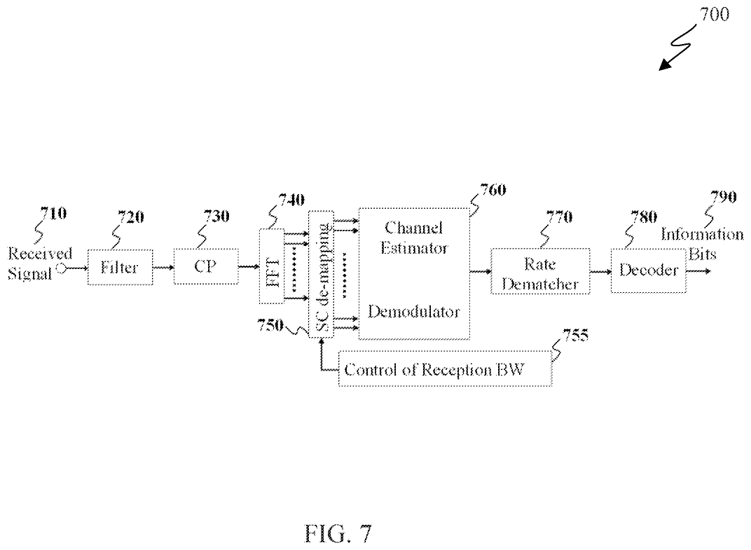

FIG. 7 illustrates an example receiver structure using OFDM 700 according to embodiments of the present disclosure. The embodiment of the receiver structure using OFDM 700 illustrated in FIG. 7 is for illustration only. One or more of the components illustrated in FIG. 7 can be implemented in specialized circuitry configured to perform the noted functions or one or more of the components can be implemented by one or more processors executing instructions to perform the noted functions. FIG. 7 does not limit the scope of this disclosure to any particular implementation of the receiver structure using OFDM 700.

As shown in FIG. 7, a received signal 710 is filtered by filter 720, a CP removal unit removes a CP 730, a filter 740 applies a fast Fourier transform (FFT), SCs de-mapping unit 750 de-maps SCs selected by BW selector unit 755, received symbols are demodulated by a channel estimator and a demodulator unit 760, a rate de-matcher 770 restores a rate matching, and a decoder 780 decodes the resulting bits to provide information bits 790.

A UE may need to report HARQ-ACK information in response to correct or incorrect decoding of a DCI format together with HARQ-ACK information in response to correct of incorrect decoding of TBs. For example, the HARQ-ACK information for a decoding of a DCI format can be for a DCI format indicating an SPS PDSCH activation/release or for a DCI format indicating a dormant/non-dormant BWP for a cell from a group of cells, and so on, as described in TS 38.213 v17.1.0 “NR; Physical Layer Procedures for Control”.

A serving gNB can provide by higher layer signaling to a UE a number of PUCCH resource sets for the UE to determine a PUCCH resource set and a PUCCH resource from the PUCCH resource set for transmission of a PUCCH with HARQ-ACK information as described in TS 38.213 v17.1.0 “NR; Physical Layer Procedures for Control”. For example, the gNB can provide by PUCCH-ResourceSet, or by SPS-PUCCH-AN-List for SPS PDSCH receptions, in PUCCH-Config a set of PUCCH resources for transmission of a PUCCH with the HARQ-ACK information. To enable flexible allocation of PUCCH resources, a PUCCH resource indicator (PRI) field can be included in a DCI format and a UE can then determine a PUCCH resource based on a value of the PRI field in a last DCI format that the UE correctly decodes. The last DCI format is provided by a PDCCH reception that starts after all other PDCCH receptions providing DCI formats with corresponding HARQ-ACK information multiplexed in a same PUCCH. In case there are multiple PDCCH receptions with a same last symbol that provide DCI formats scheduling PDSCH receptions on respective multiple cells, the last PDCCH reception is the one corresponding to a cell from the multiple cells with a largest cell index as described in TS 38.213 v17.1.0 “NR; Physical Layer Procedures for Control”. When the DCI formats indicate a priority for the HARQ-ACK information, the last DCI format is among DCI formats indicating a same priority.

An important application for wireless communications includes augmented reality (AR), cloud gaming, and virtual reality (VR) that are collectively referred to as XR. XR traffic represents a challenging scenario for a network to support due to the requirements of very large data rates, such as 30-60 Mbps for video traffic, with low end-to-end latency at the physical layer such as 10 msec. For unpaired spectrum operation, as for most NR bands, latency becomes a challenging target to meet due to the large data rate requirements and due to the scarcity of time intervals for transmissions from the UE as typical UL-DL configurations have more DL time intervals than UL time intervals. For example, a typical UL-DL configuration comprises of repeated segments of four consecutive slots (DDDDU) for DL transmissions and one slot for UL transmissions.

When a UE has new data to transmit, a serving gNB cannot schedule the UE according to its data requirements before the UE transmits a PUCCH with positive SR to indicate new data arrival and transmit another PUSCH to provide a BSR. Such conventional approach introduces a latency of at least eight slots for the DDDDU UL-DL configuration prior to a first PUSCH transmission that is dimensioned according to the data requirements of the UE and also incurs some spectral efficiency loss as the first PUSCH transmission that includes the BSR is not properly dimensioned.

In addition to latency, spectral efficiency is an important metric for XR services due to the requirement to support large data rates. Fast link adaptation for corresponding PUSCH transmission is therefore required. SRS transmissions from a UE typically serve to enable link adaptation, among other functionalities. However, an SRS transmission typically occupies a large bandwidth and are typically periodic with a relatively long period, such as 10 msec or longer or triggered by a DCI format in a PDCCH reception. Neither approach is suitable for immediate link adaptation for PUSCH transmissions due to new data arrivals as a UE may need to wait several milliseconds for an opportunity to transmit periodic SRS or need to wait for a DCI format, after a PUCCH transmission with a positive SR, to trigger SRS transmission at a later time that for unpaired spectrum operation may again be several milliseconds later.

One approach to reduce the latency for a PUSCH transmission associated with arrival of new data information at a UE is to use CG-PUSCH. A UE can be provided multiple configurations for CG-PUSCH transmissions and can select a configuration according to the data rate requirements. For example, for AR traffic, the UE can select a first configuration that includes a moderate number of RBs to transmit a first CG-PUSCH with pose/control traffic and select a second configuration that includes a large number of RBs to transmit a second CG-PUSCH with video traffic. However, although such approach can be appropriate for traffic types requiring few RBs, it is not practically feasible, or at all possible, for XR traffic as a large number of RBs needs to be reserved for each UE with XR traffic thereby leading to an inability to provide service for other traffic types.

Capacity is an important metric for XR services due to the requirement to support large data rates and corresponding enhancements beyond existing mechanisms need to exploit particular characteristics of XR video traffic. One such characteristic is that XR video traffic includes I-frames, P-frames, and B-frames with I-frames providing more critical information than P-frames that in turn provide more critical information than B-frames for the quality of service (QoS). Therefore, by performing scheduling decisions and link adaptation according to the importance of information for each TB in a PDSCH, network capacity can improve by deprioritizing less important information. For example, a network can perform scheduling such that I-frames are accurately received within a required packed delay budget (PDB) while the network can be less conservative with P-frames or B-frames and allow some of the information to not be incorrectly received or even not provided. Another characteristic is that XR video needs to be provided with a PDB requirement and the network can forgo transmissions for packets that cannot meet the PDB requirement for delivery instead of unnecessarily consuming resources as there is small quality of service difference between not delivering a packet and delivering the packet with a delay that exceeds the PDB requirement.

Link adaptation considering the characteristics of XR video traffic can be by targeting a different block error rate (BLER) for code blocks (CBs) or code block groups (CBGs) or transport blocks (TBs) associated with I-frames or slices of I-frames than for CBs or CBGs or TBs associated with P-frames or slices of P-frames. To enable a network to determine parameters for a CB, CBG, or TB reception by a UE, such as a modulation and coding scheme (MCS), according to a corresponding BLER values, the UE needs to provide separate CQI reports for the corresponding BLER values. Further, the BLER values depend on the scheduling strategy that the network would apply depending on other requirements such as for supporting other traffic types on a serving cell, on QoS requirements for a particular XR application, on a number of UEs on the serving cell, and so on.

XR video traffic is generated periodically while traffic arrivals can have a time jitter caused by codec and networks delays. That characteristic of XR video traffic can be utilized to reduce power consumption at a UE that is important for some XR devices such as AR glasses that require low power consumption. One approach to utilize the periodic nature of XR traffic is to indicate to the UE to skip PDCCH receptions, such as when a last TB for a XR packet has been correctly received by the UE, for a duration determined based on the periodicity of XR packets while also accounting for an associated time jitter. Skipping PDCCH receptions can reduce UE power consumption, but the UE should also skip a subset of other receptions or transmissions to conserve power and be able to enter a sleep state for the PDCCH skipping duration. For example, the UE does not need to perform measurement for CSI reports or to transmit PUCCHs to provide such CSI reports for at least some of the duration indicated for PDCCH skipping where the UE will not be scheduled PDSCH receptions or PUSCH transmissions.

Another mechanism for reducing UE power consumption via reduced PDCCH monitoring is to schedule multiple PDSCHs or multiple PUSCHs in a same slot or over multiple slots by a single DCI format provided by a single PDCCH. In such case, it is beneficial to enable the multiple PDSCHs or the multiple PUSCHs to provide TBs with different reliability requirements such as TBs associated with I-frames and TBs associated with P-frames. It is therefore beneficial to provide mechanisms enabling different link adaptation parameters, such as different MCS or different resource allocation in the time domain or in the frequency domain, or different priorities among the multiple PDSCH receptions or PUSCH transmissions.

For XR applications, there can be multiple data flows each having respective characteristics such as a required data rate for and a packet delay budget (PDB). The communication can be based on packet data unit (PDU) sets that include a number of PDUs with information generated at the application level, such as a frame/video slice. Individual IP packets of the PDU set are inter-dependent and need to be received within the PDB for the PDU set. In some implementations, all PDUs are needed by the application layer and an entire PDU set can be discarded if at least one PDU cannot be delivered within the PDB, while in other implementations error concealment can apply for up to a certain number of lost PDUs but the order of PDUs is then also relevant.

XR video traffic is generated periodically while traffic arrivals can have a time jitter caused by video codec and networks delays. Despite the existence of jitter, the periodicity of XR video traffic can be utilized to reduce power consumption at a UE that is important for some XR devices such as AR glasses that require low power consumption. One approach to utilize for UE power savings the periodic nature of XR traffic is to indicate to the UE to skip PDCCH receptions, such as when a last TB for a XR packet has been correctly received by the UE or by the serving gNB, for a duration determined based on the periodicity of XR packets while also accounting for an associated time jitter.

A UE may provide frequent pose/control information, such as every millisecond or every four milliseconds. The exact periodicity may depend on the UE implementation or on network configuration. An application server may then provide content depending on the pose/control information from the UE, such as for example provide content when the UE looks at a first location and not provide content when the UE looks at a second location. Due to the periodic reporting of pose/control information, the small corresponding transport block (TB) sizes and the absence of jitter, CG-PUSCH transmissions are suitable for pose/control information.

Unlike typical PUSCH transmissions from a UE, whether scheduled by a DCI format or are CG-PUSCH transmissions, a serving gNB may not need to reschedule a PUSCH transmission with pose/control information from the UE when the gNB incorrectly receives a TB and the UE may not be scheduled HARQ retransmissions for the TB. A reason is that the serving gNB may have no use for outdated pose/control information that would be provided by a HARQ retransmission of a TB in a scheduled PUSCH transmission since the UE would transmit other CG-PUSCHs with updated pose/control information prior to a slot where the UE would transmit the scheduled PUSCH with the outdated pose/control information. Also, for frequently scheduled PUSCH transmissions, such as ones providing TBs with variable size or with large size that can benefit from link adaptation which is typically not possible in practice with CG-PUSCH transmissions, it can be beneficial for the gNB to indicate absence of a HARQ retransmission, for example when a PDB would be exceeded or when the information provided by the HARQ retransmission of the TB would be outdated. When the UE knows that there is no HARQ retransmission for a TB, the UE does not need to start a drx-RetransmissionTimerUL to receive PDCCHs for scheduling a HARQ retransmission of the TB in a PUSCH and that can be beneficial for UE power savings that is important for some UE types associated with XR applications, such as AR glasses.

Similar reasons as for not scheduling a PUSCH transmission from a UE for a first TB that the UE provided in a CG-PUSCH transmission can apply for not scheduling a PDSCH reception by the UE for a second TB that the UE was provided in a SPS PDSCH reception and for which the UE reported HARQ-ACK information with NACK value, for example when frequent SPS PDSCH receptions provide updates for information associated with the second TB. Then, the UE does not need to start a drx-RetransmissionTimerDL to receive PDCCHs for scheduling a HARQ retransmission of the TB in a PDSCH, does not need to provide associated HARQ-ACK information, and therefore the UE can reduce power consumption. Although HARQ-ACK information reports can be disabled for some HARQ processes, or for some RNTIs, that is not beneficial for SPS PDSCH receptions of a given SPS PDSCH configuration for a given RNTI as corresponding HARQ process numbers vary across slots, as described in TS 38.321 v17.1.0, and for a different SPS PDSCH configuration a HARQ-ACK information reports may need to be provided. Similar considerations apply for HARQ retransmissions for TBs provided by CG-PUSCH transmissions.

The PDB requirements for XR cannot be met for typical TDD UL-DL configurations, such as a (repeating) DDDDU or a DDDSU configuration where ‘D’ denotes a slot with DL symbols, ‘U’ denotes a slot with UL symbols, and ‘S’ denotes a slot with a mixture of DL and UL symbols, for SCS of 15 kHz and 30 kHz that respectively correspond to a slot duration of 1 msec and 0.5 msec. That limitation can be somewhat mitigated when a UE is configured for operation with carrier aggregation (CA) that includes cells associated with different carriers that operate with different UL-DL configurations, for example when the carriers are located in different frequency bands. Then, latency can be reduced by switching the cell for a transmission, for example when there are two cells using the DDDSU configuration and the DDDSU configuration on one of the cells is shifted by two slots. For PUCCH transmissions, that mechanism is also referred to as PUCCH cell switching and is described in TS 38.213 v17.2.0. For PUSCH transmissions cell switching is not supported because different cells have separate MAC layers and there is no sharing of HARQ processes among cells. However, for PUSCH transmissions that do not support HARQ retransmissions for a TB, such as for pose/control information, a similar mechanism for cell switching as for PUCCH transmissions can be supported as there is no associated HARQ process for the TB.

Various embodiments of the present disclosure recognize a need to enable scheduling of PUSCH transmissions from a UE with reduced latency by a serving gNB upon arrival of new data traffic at the UE. In addition, various embodiments of the present disclosure recognize a need to enable link adaptation for a PUSCH transmission upon arrival of new data at a UE. Further, various embodiments of the present disclosure recognize a need to enable real-time adjustments of available resources for a CG-PUSCH transmission by a UE.

Various embodiments of the present disclosure recognize a need to enable scheduling of CBs or CBGs or TBs with different target BLER values. In addition, various embodiments of the present disclosure recognize a need to provide different parameters or different priorities for multiple PDSCH receptions or multiple PUSCH transmissions scheduled by a same DCI format. Various embodiments of the present disclosure recognize a need to enable CQI reports corresponding to variable BLER targets. Further, various embodiments of the present disclosure recognize a need to enable a UE to skip a subset of measurements and reports during a time period where the UE does monitor PDCCH.

Various embodiments of the present disclosure recognize a need to disable HARQ retransmissions for TBs provided by CG-PUSCH transmissions for a CG PUSCH configuration. In addition, various embodiments of the present disclosure recognize a need to disable HARQ retransmissions for a TB provided in a PUSCH transmission that is scheduled by a DCI format. Further, various embodiments of the present disclosure recognize a need to disable HARQ retransmissions for TBs provided in SPS PDSCH receptions for a SPS PDSCH configuration. Still further, various embodiments of the present disclosure recognize a need to enable cell switching for CG-PUSCH transmissions that do not support HARQ retransmissions.

Accordingly, various embodiments of the present disclosure provide mechanisms for enabling scheduling of PUSCH transmissions from a UE with reduced latency by a serving gNB upon arrival of new data traffic at the UE. In addition, various embodiments of the present disclosure provide mechanisms for enabling link adaptation for a PUSCH transmission upon arrival of new data at a UE. Further, various embodiments of the present disclosure provide mechanisms for enabling real-time adjustments of available resources for a CG-PUSCH transmission by a UE.

Various embodiments of the present disclosure provide mechanisms for enabling scheduling of CBs or CBGs or TBs with different target BLER values. In addition, various embodiments of the present disclosure provide mechanisms for providing different parameters or different priorities for multiple PDSCH receptions or multiple PUSCH transmissions scheduled by a same DCI format. Further, various embodiments of the present disclosure provide mechanisms for enabling CQI reports corresponding to variable BLER targets. In addition, various embodiments of the present disclosure provide mechanisms for enabling a UE to skip a subset of measurements and reports during a time period where the UE does monitor PDCCH.

Various embodiments of the present disclosure provide mechanisms for disabling HARQ retransmissions for TBs provided by CG-PUSCH transmissions for a CG PUSCH configuration. In addition, various embodiments of the present disclosure provide mechanisms for disabling HARQ retransmissions for a TB provided in a PUSCH transmission that is scheduled by a DCI format. Further, various embodiments of the present disclosure provide mechanisms for disabling HARQ retransmissions for TBs provided in SPS PDSCH receptions for a SPS PDSCH configuration. Still further, various embodiments of the present disclosure provide mechanisms for enabling cell switching for CG-PUSCH transmissions that do not support HARQ retransmissions.

The term “higher layers” is used to denote control information that a UE is provided in a PDSCH reception, such as radio resource control (RRC) or a medium access control (MAC) control element (CE).

In one embodiment, mechanisms to provide quantized BSR information through a PUCCH transmission that also serves to provide a positive SR are considered.

A PUCCH transmission providing a positive SR uses a modulated sequence in a same manner as a PUCCH transmission providing HARQ-ACK information as described in TS 38.211 v17.1.0 “NR; Physical channels and modulation” and in TS 38.213 v17.1.0 “NR; Physical Layer procedures for control”. For example, a PUCCH providing a positive SR can use a same structure as a PUCCH providing 1 bit or 2 bits of HARQ-ACK information using BPSK or QPSK modulation, respectively. A serving gNB can provide by higher layer signaling a mapping to two or four BSR values for the UE to provide using BPSK or QPSK modulation, respectively.

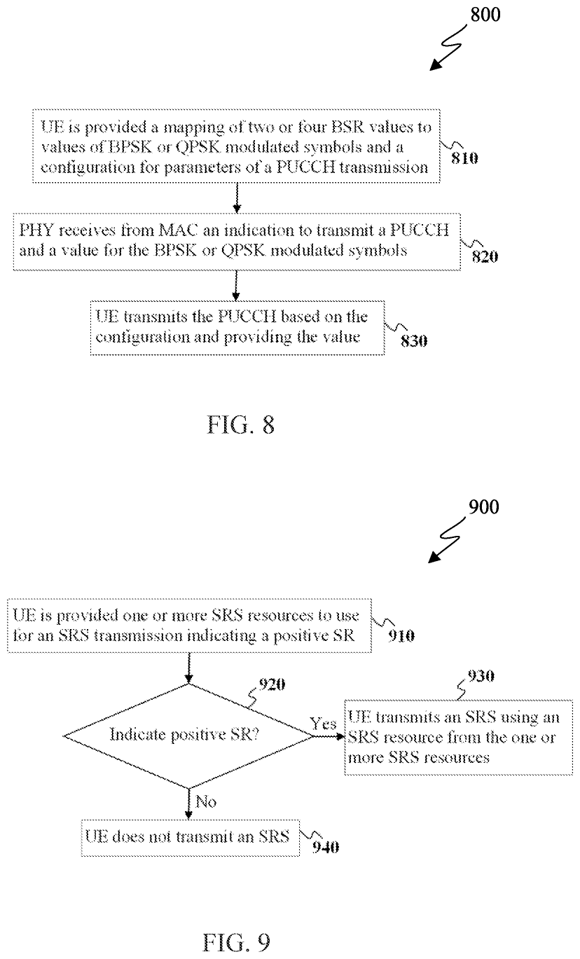

FIG. 8 illustrates an example method 800 for a UE to provide quantized BSR information in a PUCCH transmission according to embodiments of the present disclosure. The embodiment of the method 800 for a UE to provide quantized BSR information in a PUCCH transmission illustrated in FIG. 8 is for illustration only. FIG. 8 does not limit the scope of this disclosure to any particular implementation of the method 800 for a UE to provide quantized BSR information in a PUCCH transmission.

As illustrated in FIG. 8, the method 800 begins at step 810, where a UE (such as the UE 116) is provided a mapping of two or four BSR values to BPSK or QPSK modulated symbols, respectively, and a configuration for parameters of a PUCCH transmission. For example, the configuration can include a PUCCH resource and a periodicity and offset for the PUCCH transmission. At step 820, the physical layer of the UE receives from higher layers, such as the MAC layer, an indication to transmit a PUCCH and a value for the BPSK or QPSK modulated symbols. At step 830, the UE transmits the PUCCH according to the configuration and with the value for the BPSK or QPSK modulated symbols.

Due to the use of BPSK/QPSK modulation for a PUCCH transmission indicating a positive SR, a different procedure is needed for a UE to multiplex SR with HARQ-ACK information compared to the case that a PUCCH transmission indicating a positive SR is via an unmodulated sequence and the multiplexing with HARQ-ACK information is by transmitting the PUCCH providing the HARQ-ACK information using the PUCCH resource configured for a PUCCH transmission providing a positive SR.

In one approach, when BPSK modulation is used for the SR, one bit or two bits of HARQ-ACK information can be multiplexed by changing the modulation to QPSK and, in case of two HARQ-ACK bits, applying bunding (XOR operation) to the HARQ-ACK information bits wherein an ACK value is generated when both HARQ-ACK information bits have ACK value; else, a NACK value is generated. The PUCCH transmission uses the PUCCH resource associated with the SR.

In one approach, the UE can be configured by the serving gNB whether to prioritize a first PUCCH transmission with HARQ-ACK information or a second PUCCH transmission with SR, and drop the second or the first PUCCH transmission, respectively. In another approach, the system operation can specify that the UE transmits either the first PUCCH with HARQ-ACK information or the second PUCCH with positive SR.

In one embodiment, use of an SRS transmission to provide a positive SR is considered.

A benefit of using an SRS transmission from a UE to provide a positive SR is that a serving gNB can use the SRS reception to obtain a channel estimate for the UE and perform link adaptation in scheduling subsequent PUSCH transmissions from the UE based on the positive SR. The SRS transmission can additionally be configured to occur at predetermined time instances, such as in a first transmission opportunity when the UE enters the On Duration of a DRX cycle, in case the UE is configured with a DRX cycle, or at a transmission opportunity such as an UL slot within a configured time offset prior to the UE entering the DRX On Duration.

The UE can also be provided an additional configuration for PUCCH transmissions to indicate a positive SR, based on a conventional mechanism as described in TS 38.213 v17.1.0 “NR; Physical Layer procedures for control” or as described in the first embodiment, during the DRX On Duration. The UE can also be provided separate configurations for SRS transmissions indicating a positive SR and for SRS transmissions used for link adaptation, positioning, or other purposes. For determining a power for a SRS transmission indicating a positive SR, the UE can be provided a separate configuration of power control parameters, or the configuration can be same as the one used for another purpose, such as for link adaptation or for positioning.

If the UE would simultaneously transmit a first SRS to indicate a positive SR and a second SRS for another purpose, such as for link adaptation of for positioning as determined by a corresponding SRS configuration, the UE can prioritize the transmission of the first SRS for indicating a positive SR and drop the transmission of the second SRS or the reverse, or the UE can be indicated by higher layers the SRS transmission to prioritize. If the UE would simultaneously transmit an SRS to indicate a positive SR and a PUCCH, the UE can prioritize transmission for the SRS or for the PUCCH (and not transmit the PUCCH or the SRS, respectively) based on specifications of the system operation or based on a configuration by higher layers. It is also possible that the UE transmits only the PUCCH in case the PUCCH provides HARQ-ACK information and transmits only the SRS otherwise.

The UE can be provided multiple resources for an SRS transmission to select from based on an amount of data the UE needs to transmit or based on a logical channel associated with the positive SR transmission. For example, the UE can be provided by higher layers from a serving gNB a mapping for a subset of BSR values to SRS resources for the UE to select from based on a BSR value that the UE needs to indicate through the SRS transmission. For example, the UE can be provided by higher layers from a serving gNB a mapping of logical channels to SRS resources for the UE to select from based on a logical channel that the UE needs to associate a positive SR with.

FIG. 9 illustrates an example method 900 for a UE to transmit an SRS to indicate a positive SR according to embodiments of the present disclosure. The embodiment of the method 900 for a UE to transmit an SRS to indicate a positive SR illustrated in FIG. 9 is for illustration only. FIG. 9 does not limit the scope of this disclosure to any particular implementation of the method 900 for a UE to transmit an SRS to indicate a positive SR.

As illustrated in FIG. 9, the method 900 begins at step 910, where a UE (such as the UE 116) is provided by a gNB a configuration of one or more SRS resources to use for an SRS transmission that indicates a positive SR. At step 920 the UE determines whether or not to indicate a positive SR. When the UE determines to provide the positive SR, the UE transmits the SRS using an SRS resource from the one or more SRS resources 930; otherwise, the UE does not transmit the SRS 940.

In one embodiment, a procedure for a UE to determine resources for a CG-PUSCH transmission based on an indication by control information at the physical layer using a DCI format is considered.

CG-PUSCH transmissions can minimize latency as a delay associated with transmission of a PUCCH by a UE to provide a positive SR, a delay associated with a subsequent scheduling grant for a PUSCH transmission, and a delay for the scheduled PUSCH transmission by the UE are avoided. However, reserved resources are required for the UE to transmit CG-PUSCH and those resources cannot be used for other transmissions in a slot where the UE can transmit CG-PUSCH. For traffic characteristics that include large and variable TB sizes, it can be infeasible for a serving gNB to reserve corresponding resources for CG-PUSCH transmissions, or such transmissions may be supported for only few UE, and it may not be typically possible for the gNB to schedule other traffic.

For a serving gNB to control in real time the available UL resources, the serving gNB can use for scheduling any of the UL resources based on physical layer control information provided by DCI formats in PDCCH receptions. The resources can be in one or more of a frequency domain in terms of RBs, a time domain in terms of symbols, and a spatial domain in terms of spatial filters for UL transmissions. It is also possible that the gNB configures by higher layers a fraction of the UL resources for UL transmissions and that fraction of the UL resources is not available for scheduling by DCI formats. Under such operation, any material restriction on the gNB scheduler for UL transmissions is avoided and the gNB can determine in real time how many UL resources to keep available for CG-PUSCH transmissions that do not have guaranteed UL resources.

After the gNB schedules UL transmissions in a slot and considers other UL transmissions with configured resources, the gNB can determine the available UL resources in the slot. The gNB can inform the available UL resources in the slot to UEs, for example by information provided by a DCI format in a PDCCH transmission. A UE configured for CG-PUSCH transmissions in resources that are not guaranteed and can only occur based on an indicated availability by the DCI format, can be provided by the gNB a search space set associated with the DCI format for PDCCH monitoring. For example, for indication of available UL resources in a slot by a DCI format, the UE can monitor PDCCH for detection of the DCI format only in a last slot where the gNB can schedule transmissions from UEs in the slot.

If the UE is provided multiple configurations of resources (set of resources) for CG-PUSCH transmissions, the UE can select the configuration providing the maximum resources, in terms of number of REs available for CG-PUSCH transmission, that are indicated to be available by the DCI format. That avoids a gNB having to determine the resources (CG-PUSCH configuration), from the set of resources (set of CG-PUSCH configurations), that the UE used to transmit CG-PUSCH. It is also possible that the UE selects resources from the set of resources that are sufficient for the UE to provide a TB with a target code rate wherein the target code rate can be provided to the UE by the gNB through higher layer signaling.

A UE can be configured both a first set of guaranteed resources for CG-PUSCH transmissions and a second set of non-guaranteed resources wherein resources from the second set can be used for a CG-PUSCH transmissions only if indicated as available by the DCI format. Whether a resource is guaranteed to be available, and can then be used by the UE for example when the UE does not detect the DCI format indicating UL resource availability in a slot, or is determined to be available based on the DCI format indication for available UL resources, can be indicated by higher layers as part of a resource configuration or, in general, as part of a CG-PUSCH configuration.

A DCI format can indicate available resources for CG-PUSCH transmissions in a slot by indicating one or more of available frequency resources in terms of RBs or RB groups (RBGs) or a configured granularity of RBs, available time resources in terms of symbols or groups of symbols with a configured granularity such as 2 symbols, or available spatial resources in terms of spatial filters from a predetermined or configured set of spatial filters, in the slot. It is also possible that instead of available resources, the DCI format indicates unavailable resources, and the UE determines the available resources from the frequency or time or spatial resources that are not indicated as unavailable.

If the UE does not detect the DCI format at a PDCCH monitoring occasion according to the search space set, in a first approach the UE does not transmit a CG-PUSCH. In a second approach, when the UE is provided a set of guaranteed resources, the UE may transmit a CG-PUSCH associated using the minimum resources from the set guaranteed resources that are required to provide a TB with a target code rate in the CG-PUSCH transmission, or using any resources from the set of guaranteed resources for a corresponding CG-PUSCH configuration.

The serving gNB can balance in time the resources indicated as available to UEs in order for the UEs to achieve corresponding data rates for their traffic types. For example, the gNB can use for scheduling transmissions from UEs in a first slot more of the resources associated with a first UE, thereby indicating a smaller amount of available resources to the first UE in the first slot, and use for scheduling transmissions from UEs in a second slot less of the resources associated with the first UE, thereby indicating a larger amount of available resources to the UE in the second slot.

In an exemplary realization, a UE can be provided by a serving gNB a set of resources that includes first, second, and third resources for CG-PUSCH transmissions. Equivalently, the UE can be provided a set of first, second, and third CG-PUSCH configurations that include corresponding first, second, and third resources for CG-PUSCH transmissions. The total number of REs for a CG-PUSCH transmission is smallest for the first resource and largest for the third resource. The first resources can be indicated as guaranteed for the UE to use for a CG-PUSCH transmission in any slot, or according to a configured slot pattern, and the second and third resources can be available for a CG-PUSCH transmission in a slot only if indicated by a DCI format to be available in the slot.

For the exemplary realization, the UE is provided one or more search space sets to monitor PDCCH for detection of a DCI format indicating available resources. When the UE does not detect the DCI format for indication of available resources in a slot, or when the UE detects the DCI format that does not indicate the second or third resources as available in the slot, the UE considers only the first resources to be available in the slot. If the UE would transmit a CG-PUSCH in the slot, the UE transmits the CG-PUSCH using the first resources. When the UE detects the DCI format that indicates the second resources as available in the slot and the third resources as unavailable in the slot and the UE would transmit a CG-PUSCH in the slot, the UE transmits the CG-PUSCH using the second resources. When the UE detects the DCI format that indicates the third resources as available in the slot and the UE would transmit a CG-PUSCH in the slot, the UE transmits the CG-PUSCH using the third resources. It is also possible that the UE selects the resources that are sufficient for the UE to transmit a TB with a target code rate wherein the target code rate can be provided to the UE by the gNB through higher layer signaling.

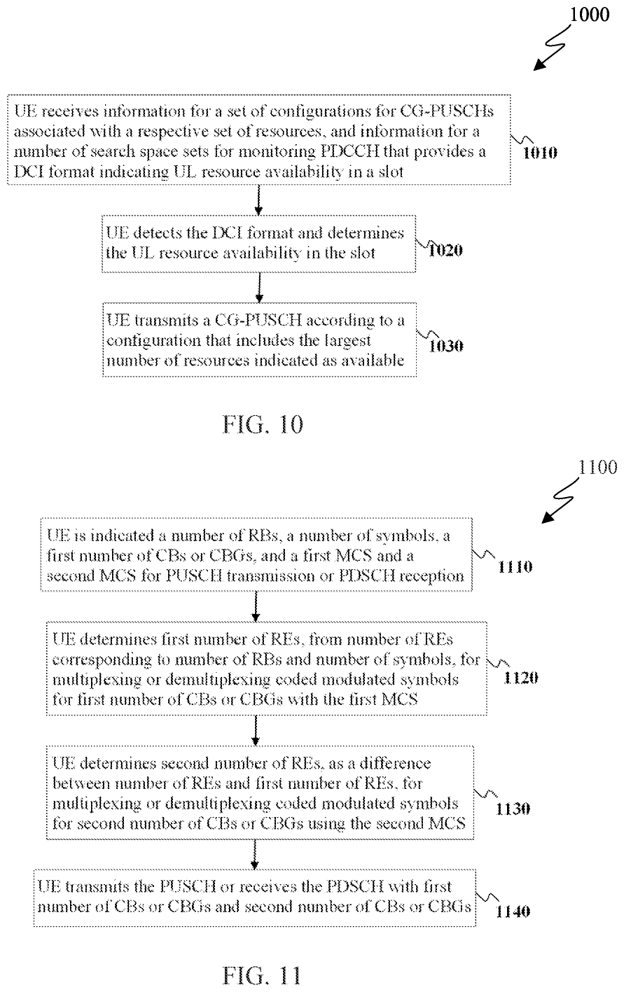

FIG. 10 illustrates an example method 1000 for a UE to determine resources for a configured CG-PUSCH transmission based on an indication of available resources by a DCI format according to embodiments of the present disclosure. The embodiment of the method 1000 for a UE to determine resources for a configured CG-PUSCH transmission based on an indication of available resources by a DCI format illustrated in FIG. 10 is for illustration only. FIG. 10 does not limit the scope of this disclosure to any particular implementation of the method 1000 for a UE to determine resources for a configured CG-PUSCH transmission based on an indication of available resources by a DCI format.

As illustrated in FIG. 10, the method 1000 begins at step 1010, where a UE (such as the UE 116) receives higher layer signaling from a serving gNB that provides a set of configurations for CG-PUSCH transmissions that are associated with a corresponding set of resources, and receives higher layer signaling providing a number of search space sets for monitoring PDCCH providing a DCI format, wherein the DCI format indicates UL resource availability in a slot. At step 1020, the UE detects the DCI format and determines the UL resource availability in the slot. At step 1030, the UE transmits a CG-PUSCH according to a CG-PUSCH configuration, from the set of CG-PUSCH configurations, which includes the largest number of resources in terms of REs wherein all resources are indicated as available by the DCI format.

In one embodiment, mechanisms to schedule CBs or CBGs with different coding rates in a PUSCH or PUSCH and for indicating a number of CBs or CBGs for each coding rate are considered.

For SPS PDSCH receptions or CG PUSCH transmissions, a UE can be provided/indicated by a serving gNB, for a corresponding SPS PDSCH configuration or a corresponding CG PUSCH configuration, a first number of CBs, or equivalently for an indicated number of CBs per CBGs, a first number of CBGs that include data information of a first priority. The UE can also be provided/indicated a second number of CBs or a second number of CBGs that include data information of a second priority. It is also possible that, instead of being indicated by the serving gNB, the second number is derived by the UE based on a total number of CB s in a SPS PDSCH reception or a CG PUSCH transmission that the UE can determine based on the corresponding time-frequency resources for a first MCS associated with the first number of CBs or CBGs and for a second MCS associated with the second number of CBs or CBGs. The first MCS and the second MCS can be indicated in the corresponding SPS PDSCH configuration or CG PUSCH configuration. The first MCS and the second MCS can be restricted to be associated with a same modulation scheme and differ only in the coding rate. The first MCS or the second MCS can also be indicated with an offset to an indicated second MCS or first MCS, respectively.

The serving gNB can indicate the first number or the second number as an absolute number of CBs or CBGs or as a percentage of the total number of CBs or CBGs. In the latter case, when a percentage of the total number of CBs or CBGs is not an integer, the floor function or the ceiling function can additionally apply to the percentage of the total number of CBs or CBGs in order to obtain an integer number for the first number or the second number of CBs or CBGs.

For example, the first number of CBs or CBGs can be ones corresponding to I-frames and have a first priority value and the second number of CBs or CBGs can be the ones corresponding to P-frames and have a second priority value. The first priority value can be 1 and the second priority value can be 0.

For example, for a CG PUSCH configuration with time-frequency resources resulting to a number of REs for multiplexing coded modulated symbols for example as described in TS 38.214 v17.1.0 “NR; Physical layer procedures for data”, a UE can determine a first number of REs for multiplexing the first number of CBs or CBGs according to the first MCS based on an indication of the first number of CBs or CBGs and of the first MCS by the serving gNB for the CG PUSCH configuration. Subsequently, after subtracting the first number of REs from the number of REs to obtain a second number of REs, the UE can determine the second number of CBs or CBGs based on the second number of REs and the second MCS. The multiplexing of coded modulated symbols for the first CBs or CBGs and the second CBs or CBGs in a PUSCH transmission can be according to an order that is defined in the specifications of the system operations such as multiplexing coded modulated symbols for the first CBs or CBGs first and multiplexing coded modulated symbols for the second CBs or CBGs second, or the reverse, or multiplexing coded modulated symbols for the CBs or CBGs having the larger priority first, and so on.

For a PDSCH reception or a PUSCH transmission by a UE that is scheduled by a DCI format provided in a PDCCH reception, the indication for the first number of CBs or CBGs and for the first MCS and the second MCS can be provided by the DCI format. The first number of CBs or CBGs can range from 0 to the maximum number of CBs or CBGs corresponding to the number of REs of the time-frequency resources (symbols and RBs) indicated by the DCI format and can be used for multiplexing coded modulated symbols according to the first MCS. Similar for the second number of CBs or CBGs. The second number of CBs or CBGs can also be indicated by the DCI format or can be determined by the UE as described in the above paragraph for a SPS PDSCH or a CG PUSCH based on the first number of CBs or CBGs, the first MCS and the second MCS, and the time-frequency resources of the PDSCH or the PUSCH that the UE uses for multiplexing coded modulated symbols. The first MCS and the second MCS can be restricted to be associated with a same modulation scheme and differ only in the coding rate. The first MCS or the second MCS can also be indicated with an offset to an indicated second MCS or first MCS, respectively.

When a UE transmits a CG PUSCH, or a PUSCH scheduled by a DCI format, that includes CBs or CBGs of different priority values, the UE determines a corresponding power assuming that all CBs or CBGs have the priority value associated with larger priority. When a UE transmits a PUCCH with first HARQ-ACK information associated with the first CBs or CBGs and with second HARQ-ACK information associated with the second CBs or CBGs and the first and second HARQ-ACK information have different priority values, the UE determines a corresponding power assuming that all HARQ-ACK information has the priority value associated with larger priority.

FIG. 11 illustrates an example method 1100 for a UE to transmit a PUSCH, or receive a PDSCH, that includes CBs or CBGs with different MCS according to embodiments of the present disclosure. The embodiment of the method 1100 for a UE to transmit a PUSCH, or receive a PDSCH, that includes CBs or CBGs with different MCS illustrated in FIG. 11 is for illustration only. FIG. 11 does not limit the scope of this disclosure to any particular implementation of the method 1100 for a UE to transmit a PUSCH, or receive a PDSCH, that includes CBs or CBGs with different MCS.

As illustrated in FIG. 11, the method begins at step 1110, where a UE (such as the UE 116) is indicated a number of RBs, a number of symbols, a first number of CBs or CBGs, and a first MCS and a second MCS for a PUSCH transmission or a PDSCH reception. At step 1120, based on the first number of CBs and the first MCS, the UE determines a first number of REs from the number of REs associated with the number of RBs and the number of symbols, for multiplexing or demultiplexing coded modulated symbols for the first number of CBs or CBGs using the first MCS. At step 1130, the UE determines a second number of REs as a difference between the number of REs and the first number of REs, for multiplexing or demultiplexing coded modulated symbols for the second number of CBs or CBGs using the second MCS. The UE can multiplex or demultiplex first the first number of CBs or CBGs followed by the second number of CBs or CBGs, or the reverse, or can interleave the multiplexing or demultiplexing of the first number of CBs or CBGs and the second number of CBs or CBGs based on the specifications for the system operation. At step 1140, the UE transmits the PUSCH or receives the PDSCH with the first number of CBs or CBGs and the second number of CBs or CBGs.

When a single DCI format schedules to a UE multiple PDSCH receptions or multiple PUSCH transmissions, the previously described mechanisms for multiplexing CBs or CBGs with different MCS and possibly with different priorities, in a same PDSCH reception or a same PUSCH transmission can apply to multiplexing TBs with different MCS and possibly with different priorities in the multiple PDSCH receptions or PUSCH transmissions. The DCI format can indicate a total number of PDSCH receptions or PUSCH transmissions. For one PDSCH reception per slot or one PUSCH transmission per slot, which is equivalent to indicating a corresponding total number of slots and the indication can be either through a corresponding dedicated field indicated a number of slots or through a time domain resource allocation (TDRA) field indicating an entry that includes multiple slots and a number of symbols per slot. The DCI format can also indicate a first number of PDSCH receptions or PUSCH transmissions over a corresponding first number of slots. The UE can derive a second number of slots for the PDSCH receptions or PUSCH transmissions to be a difference of the total number and the first number. Alternatively, instead of indicating the total number of slots for PDSCH receptions or PUSCH transmissions, the DCI format can indicate the second number of slots. The DCI format also indicates a first MCS for the first number of PDSCH receptions or PUSCH transmissions and a second MCS for the second number of PDSCH receptions or PUSCH transmissions. The second MCS can be directly indicated from an MCS table by a separate MCS field in the DCI format or can be indicated as an offset in the MCS table from the first MCS. The first and second PDSCH receptions or PUSCH transmissions can have respective first and second priority values. The priority values can be indicated by the DCI format or first and second priority values can be associated with the first and second PDSCH receptions or PUSCH transmissions, respectively, based on indication by higher layers or by default based on the specifications of the system operation. The first PDSCH receptions or PUSCH transmissions can have a larger priority than the second PDSCH receptions or PUSCH transmissions, for example because they result to lower reception or transmission latency, respectively.

When a UE receives multiple PDSCHs scheduled by a DCI format over multiple slots, the UE can provide corresponding HARQ-ACK information in a same PUCCH transmission or in separate PUCCH transmissions. For the latter case, the PUCCH transmissions can have different priority values and provide HARQ-ACK information of corresponding different priority values. The DCI format can separately indicate a resource for each PUCCH transmission, or a resource for the second PUCCH transmission can be linked to a resource for the PUCCH transmission, for example through an offset indicated by the DCI format or by higher layers or defined in the specifications, or a resource can be same for both PUCCH transmissions. The DCI format can separately indicate a first slot and a second slot for the first and second PUCCH transmissions, respectively. Alternatively, the DCI format can indicate a slot for the first PUCCH transmission and the slot for the second PUCCH transmission can be a first next slot where the UE can transmit the second PUCCH using the indicated resource.

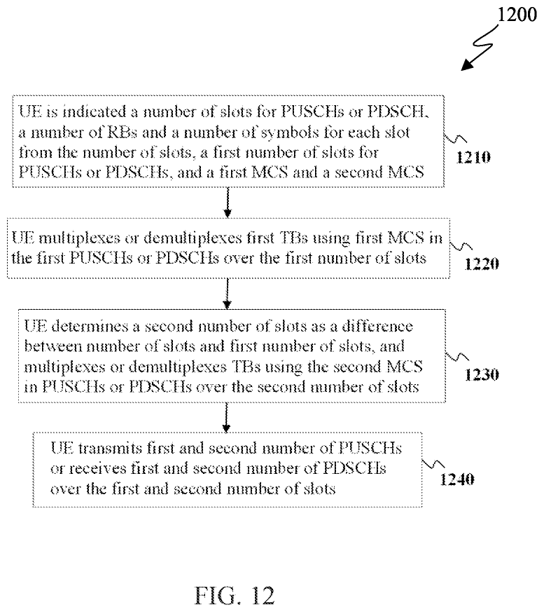

FIG. 12 illustrates an example method 1200 for a UE to transmit a PUSCH, or receive a PDSCH, that includes CBs or CBGs with different MCS according to embodiments of the present disclosure. The embodiment of the method 1200 for a UE to transmit a PUSCH, or receive a PDSCH, that includes CBs or CBGs with different MCS illustrated in FIG. 12 is for illustration only. FIG. 12 does not limit the scope of this disclosure to any particular implementation of the method 1200 for a UE to transmit a PUSCH, or receive a PDSCH, that includes CBs or CBGs with different MCS.

As illustrated in FIG. 12, the method begins at step 1210, where a UE (such as the UE 116) is indicated a number of slots for PUSCH transmissions or PDSCH receptions, a number of RB s and a number of symbols that can be same or different in each slot from the number of slots, a first number of slots for PUSCH transmissions or PDSCH receptions, and a first MCS and a second MCS. At step 1220, the UE multiplexes or demultiplexes first TBs using the first MCS in the first PUSCH transmissions or PDSCH receptions over the first number of slots. At step 1230, the UE determines a second number of slots, for example as a difference between the number of slots and the first number of slots, and multiplexes or demultiplexes TBs using the second MCS in PUSCHs or PDSCHs over the second number of slots. Alternatively, instead of the UE being indicated the number of slots, the UE can be directly indicated the second number of slots or a total number of PUSCH transmissions or PUSCH receptions. The UE can respectively first receive or transmit the first number of PUSCHs or PDSCHs and then transmit or receive the second number of PUSCH or PDSCHs, or the reverse, or can interleave the reception or transmission of the first number of PUSCHs or PDSCHs and the second number of PUSCHs or PDSCHs based on the specifications of the system operation. At step 1240, the UE transmits the first and second number of PUSCHs or receives the first and second number of PDSCHs over the first and second number of slots, respectively. The first and second PUSCHs can have different priorities. HARQ-ACK information associated with the first and second PDSCHs can have different priorities.

In one embodiment, mechanisms for a UE to report multiple CQI values corresponding to different target BLERs are considered.

For video traffic, CBs, CBGs, or TBs associated with I-frames can require different reception reliability or PDB that P-frames or B-frames and can therefore require different scheduling strategies and link adaptation by a serving gNB.

In one approach, a UE is provided different configurations for CSI reports associated with different target BLERs. A target BLER can also be informed as part of a CSI report configuration. For example, a first CSI report configuration can include a first BLER target, such as 10%, and a second CSI report configuration can include a second BLER target such as 0.1% and the UE indicates a first CQI value for the first CSI report that maps to a first entry of a first CQI table and a second CQI value for the second CSI report that maps to a second entry of a second CQI table. The first and second CQI tables can be same or different and correspond to same or difference MCS tables. A PUCCH transmission with the first CSI report, or the first CSI report, can have a first priority value, such as zero, while a PUCCH transmission with the second CSI report, or the second CSI report, can have a second priority value, such as one.

In one approach, a UE reports more than one CQI values as part of a same CSI report. The corresponding target BLERs associated with the more than one CQI values can be indicated as part of the CSI report configuration or can be defined in the specifications of the system operation. A first CQI value can indicate an entry to a CQI table. Remaining CQI values can also indicate respective entries to the CQI table or indicate offsets to the entry of the CQI table that is indicated by the first CQI value. It is also possible that remaining CQI values are associated with respective CQI tables that are indicated as part of the CSI report configuration.

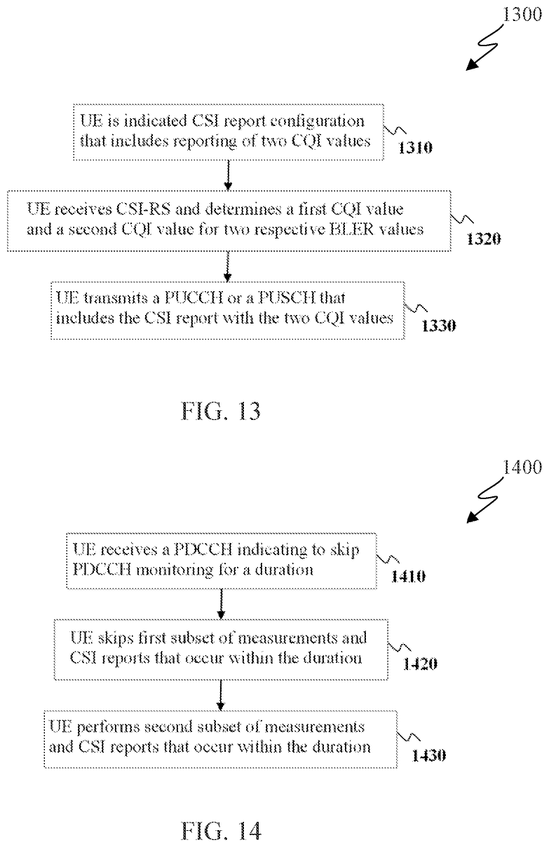

FIG. 13 illustrates an example method 1300 for a UE to report multiple CQI values in a CSI report according to embodiments of the present disclosure. The embodiment of the method 1300 for a UE to report multiple CQI values in a CSI report illustrated in FIG. 13 is for illustration only. FIG. 13 does not limit the scope of this disclosure to any particular implementation of the method 1300 for a UE to report multiple CQI values in a CSI report.

As illustrated in FIG. 13, the method 1300 begins at step 1310, where a UE (such as the UE 116) is indicated a CSI report configuration that includes reporting of two CQI values. The two CQI values are associated with two respective BLER values where one or both of the two BLER values can be defined in the specifications of the system operation or can be indicated in the CSI report configuration. At step 1320, the UE receives one or more reference signals, such as CSI-RS, and based on respective measurements, the UE determines a first CQI value and a second CQI value for the two respective BLER values. The first CQI value indicates a first entry to a CQI table that can also be included in the CSI report configuration and the second CQI value indicates a second entry to the CQI table. The second CQI value can be absolute or an offset to the first CQI value. At step 1330, the UE transmits a PUCCH or a PUSCH that includes the CSI report with the two CQI values. The second CQI value can also be from a second CQI table that is included in the CSI report configuration.

In one embodiment, mechanisms for a UE to skip CSI measurements and reports based on an indication by a serving gNB are considered.

When a buffer for a UE at a serving gNB is empty and the UE has provided all data in its buffer, the serving gNB can indicate to the UE to skip PDCCH receptions for a time duration in order to conserve power. The time duration can be indicated by a DCI format, for example using a field with value indicating an index in a set of time durations that the gNB previously indicated to the UE via higher layer signaling. For example, for video traffic having a certain periodicity, after a packet for a UE that arrives at a first time instance at the gNB is successfully received by the UE, the UE can be indicated to skip PDCCH reception until a second time instance that the gNB can determine according to the periodicity, possibly including some adjustment to capture a time jitter.

When the UE does not monitor PDCCH for scheduling at least UE-specific PDSCH receptions, the UE does not need to provide CSI reports associated with link adaptation of PDSCH receptions. For example, when a UE is indicated to skip PDCCH monitoring for next 20 msec and the UE is configured to provide two CSI reports during the next 20 msec, the UE can skip measurements for the earlier of the two CSI report and skip a PUCCH or PUSCH transmission with the earlier of the two CSI reports. The CSI reports that a UE skips for corresponding measurements and PUCCH or PUSCH transmissions with the CSI reports can be defined in the specifications of the system operation or can be indicated by the serving gNB.

For example, it can be specified that a UE skips measurements and PUCCH or PUSCH transmissions for all corresponding CSI reports except for a last CSI report prior to resuming PDCCH monitoring after the indicated PDCCH monitoring skipping duration.

For example, it can be specified that a UE skips measurements and PUCCH or PUSCH transmissions for all corresponding CSI reports until a time offset from resuming PDCCH monitoring after the indicated PDCCH monitoring skipping time duration. Alternatively, it can be specified that a UE measures CSI and provides CSI reports in PUCCH or PUSCH transmissions starting from a time offset until the time when the UE resumes PDCCH monitoring after the indicated PDCCH monitoring skipping time duration. The time offset can be specified, such as 4 msec, or can be indicated by the serving gNB for example by the DCI format indicating the time duration for skipping PDCCH monitoring or by higher layer signaling.

For example, a maximum number of CSI reports that a UE provides within the time duration where the UE skips PDCCH monitoring can be indicated to the UE by the DCI format indicating the time duration for skipping PDCCH monitoring or by higher layer signaling.

In addition to CSI measurements and reports, the UE can skip other measurements and reports such as for radio resource management (RRM) including reference signal received power (RSRP) measurements and reports.

FIG. 14 illustrates an example method 1400 for a UE to skip measurements according to embodiments of the present disclosure. The embodiment of the method 1400 for a UE to skip measurements illustrated in FIG. 14 is for illustration only. FIG. 14 does not limit the scope of this disclosure to any particular implementation of the method 1400 for a UE to skip measurements.

As illustrated in FIG. 14, at step 1410, a UE (such as the UE 116) receives a PDCCH or a PDSCH that provides an indication to the UE to skip PDCCH monitoring for a time duration. At step 1420, for a set of measurements for obtaining CSI, and a corresponding set of PUCCH or PUSCH transmissions providing CSI reports, that occur after the PDCCH or the PDSCH reception and prior to resuming PDCCH receptions after the time duration, the UE skips a first subset of measurements and skips a first subset of corresponding PUCCH or PUSCH transmissions providing CSI reports. At step 1430, the UE performs a second subset of measurements for obtaining CSI and transmits a second subset of corresponding PUCCH or PUSCH providing CSI reports. The UE can determine the CSI measurements to skip or not skip, and the PUSCH or PUCCH transmissions with CSI reports to skip or not skip, according to one or more of the aforementioned examples.

In one embodiment, mechanisms to disable HARQ retransmissions for TBs provided by CG-PUSCH transmissions or by SPS PDSCH receptions are considered. CG-PUSCH transmissions are first considered.

Disabling of HARQ retransmissions is applicable for all HARQ processes associated with TBs for a CG-PUSCH configuration. The disabling can be separately indicated by an RRC parameter per CG-PUSCH configuration. The RRC parameter can indicate either enabling or disabling of HARQ retransmissions for a CG-PUSCH configuration or, when provided, can have a single value that indicates disabling of HARQ retransmissions and then enabling of HARQ retransmissions is default operation when the RRC parameter is not provided.

Disabling HARQ retransmissions per CG-PUSCH configuration enables HARQ retransmissions to be supported for TBs associated with a first CG-PUSCH configuration and to not be supported for TBs associated with a second CG-PUSCH configuration. For example, the first CG-PUSCH configuration can be associated with TBs corresponding to voice packets for which HARQ retransmission can be beneficial, at least when provided within a time limit such as 10 msec, while the second CG-PUSCH configuration can be associated with TBs corresponding to pose/control information for which HARQ retransmissions may not be beneficial as they would provide outdated information. Both the first and second CG-PUSCH configurations can be associated with a same RNTI, such as a cell-RNTI (C-RNTI). For the second CG-PUSCH configuration, HARQ retransmissions are disabled for all HARQ processes. For the first CG-PUSCH configuration, HARQ retransmissions can be additionally disabled for some HARQ processes while HARQ retransmissions are enabled for remaining HARQ processes. The same can apply for first and second SPS PDSCH configurations.

FIG. 15 illustrates an example method 1500 for indicating to a UE disabling of HARQ retransmissions for a CG-PUSCH configuration by a parameter associated with the CG-PUSCH configuration according to embodiments of the present disclosure. The embodiment of the method 1500 for indicating to a UE disabling of HARQ retransmissions for a CG-PUSCH configuration by a parameter associated with the CG-PUSCH configuration illustrated in FIG. 15 is for illustration only. FIG. 9 does not limit the scope of this disclosure to any particular implementation of the method 1500 for indicating to a UE disabling of HARQ retransmissions for a CG-PUSCH configuration by a parameter associated with the CG-PUSCH configuration.

As illustrated in FIG. 15, at step 1510, a UE (such as the UE 1510) receives RRC information indicating parameters for a CG-PUSCH configuration. At step 1520, the UE determines whether the parameters include a parameter indicating disabling HARQ retransmissions for the CG-PUSCH configuration. When the parameter is included, the UE does not monitor PDCCH (receive PDCCH and decode a respective DCI format), and does not start a drx-RetransmissionTimerUL timer, for HARQ retransmissions associated with the CG-PUSCH configuration 1530; otherwise, the UE monitors PDCCH for HARQ retransmissions associated with the CG-PUSCH configuration 1540.

Instead of indicating disabling of HARQ retransmissions associated with CG-PUSCH transmissions as part of a corresponding CG-PUSCH configuration, for Type 2 CG PUSCH transmissions, as described in TS 38.214 v17.2.0, the indication can be provided by a DCI format activating Type 2 CG-PUSCH transmissions for the CG-PUSCH configuration as described in TS 38.213 v17.2.0. A number of fields in a DCI format is used by a UE to validate that the DCI format activates Type-2 CG-PUSCH transmissions when the fields have predetermined values that are defined in the specifications of the system operation, as described in TS 38.213 v17.2.0 and, in case the UE is provided multiple Type 2 CG-PUSCH configurations, a value of the HARQ process number field in the DCI format indicates the activated Type 2 CG PUSCH configuration. Remaining fields in the DCI format have undefined values and one of those remaining fields can be used to indicate disabling of HARQ retransmissions for the CG PUSCH configuration. For example, a predetermined value of transmit power control (TPC) command field in a DCI format scheduling PDSCH receptions or PUSCH transmissions, such as for example a value ‘11’ when the field includes 2 bits, can be used to indicate whether HARQ retransmissions for the activated CG PUSCH configuration are disabled.

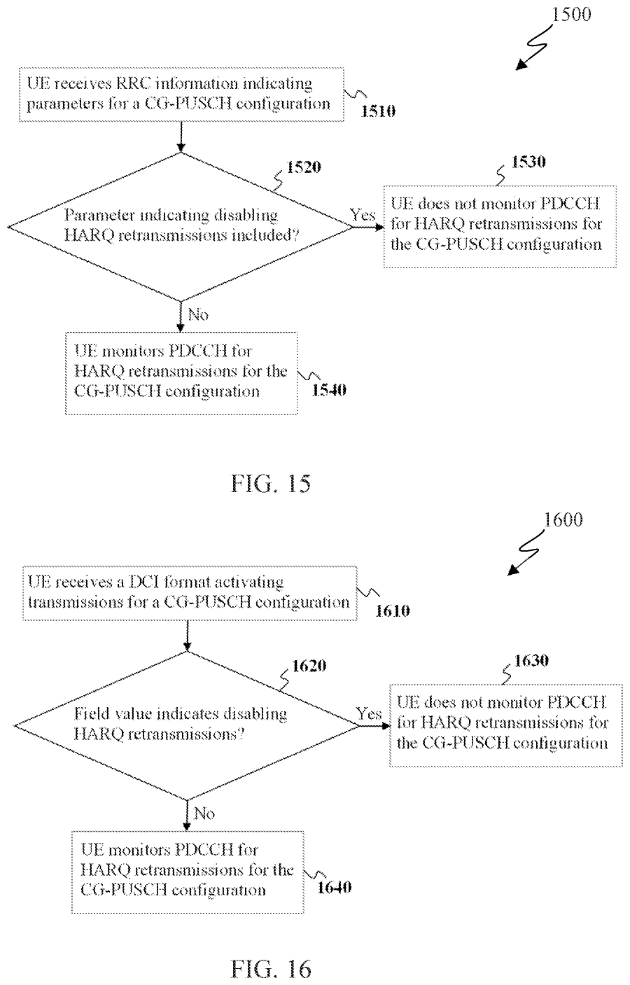

FIG. 16 illustrates an example method 1600 for indicating to a UE disabling of HARQ retransmissions for a CG-PUSCH configuration by a DCI format activating CG PUSCH transmissions for the CG-PUSCH configuration according to embodiments of the present disclosure. The embodiment of the method 1600 for indicating to a UE disabling of HARQ retransmissions for a CG-PUSCH configuration by a DCI format activating CG PUSCH transmissions for the CG-PUSCH configuration illustrated in FIG. 16 is for illustration only. FIG. 16 does not limit the scope of this disclosure to any particular implementation of the method 1600 for indicating to a UE disabling of HARQ retransmissions for a CG-PUSCH configuration by a DCI format activating CG PUSCH transmissions for the CG-PUSCH configuration.

As illustrated in FIG. 16, the method 1600 begins at step 1610, where a UE (such as the UE 116) receives a DCI format that activates transmissions for a Type 2 CG-PUSCH configuration. At step 1620, the UE determines whether a predetermined field in the DCI format has a predetermined value, that is for example defined in the specifications of the system operation, indicating disabling HARQ retransmissions for the CG-PUSCH configuration. When the predetermined field has the predetermined value, the UE does not monitor PDCCH (receive PDCCH and decode a respective DCI format), and does not start a drx-RetransmissionTimerUL timer, for HARQ retransmissions associated with the CG-PUSCH configuration 1630; otherwise, the UE monitors PDCCH for HARQ retransmissions associated with the CG-PUSCH configuration 1640.

Similar to a CG-PUSCH configuration, disabling of HARQ retransmissions can be applicable for all HARQ process numbers associated with TBs in SPS PDSCH receptions for a SPS PDSCH configuration. Parameters for a SPS PDSCH configuration can include a parameter indicating disabling of HARQ retransmissions for respective SPS PDSCH receptions where, if the parameter is not provided, a default operation would be to enable HARQ retransmissions. Alternatively, the parameter can be included in the SPS PDSCH configuration and have a value for enabling HARQ retransmissions or a value for disabling HARQ retransmissions for SPS PDSCH receptions associated with the SPS PDSCH configuration. A UE does not monitor PDCCH and does not start a drx-RetransmissionTimerDL timer, for HARQ retransmissions associated with the SPS PDSCH configuration.

Instead of indicating disabling of HARQ retransmissions for a SPS PDSCH configuration by one of the RRC parameters of the SPS PDSCH configuration, a serving gNB can indicate such disabling via a DCI format activating SPS PDSCH receptions for the SPS PDSCH configuration. Similar to activation of CG-PUSCH transmissions for a CG-PUSCH configuration, a number of fields in a DCI format is used by a UE to validate that the DCI format activates SPS PDSCH receptions when the fields have predetermined values that are defined in the specifications of the system operation as described in TS 38.213 v17.2.0. In case the UE is provided multiple SPS PDSCH configurations, a value of the HARQ process number field in the DCI format indicates the activated SPS PDSCH configuration. Remaining fields in the DCI format have undefined values and one of those remaining fields can be used to indicate disabling of HARQ retransmissions for the SPS PDSCH configuration. For example, a predetermined value of transmit power control (TPC) command field in a DCI format scheduling PDSCH receptions or PUSCH transmissions, such as for example a value ‘11’ when the field includes 2 bits, can be used to indicate whether HARQ retransmissions for the activated SPS PDSCH configuration are disabled.

When a UE is indicated that HARQ retransmissions for SPS PDSCH receptions associated with a SPS PDSCH configuration are disabled, the UE can either include or exclude the SPS PDSCH configuration in the SPS PDSCH configurations for which the UE provides HARQ-ACK information. The UE behavior can be defined in the specifications of the system operation or can be indicated by higher layers. An exception can be the case where the UE provides HARQ-ACK information according to a Type-1 HARQ-ACK codebook, as described in TS 38.213 v17.2.0, and the indication for disabling of HARQ retransmissions is provided by a DCI format activating SPS PDSCH reception for the SPS PDSCH configuration. In that case, the UE can provide HARQ-ACK information for example as when HARQ retransmissions are enabled, or report a NACK value for SPS PDSCH receptions for the SPS PDSCH configuration, or report any value that the UE chooses to report for the HARQ-ACK information. Alternatively, the UE may not expect to be indicated to provide HARQ-ACK information according to a Type-1 HARQ-ACK codebook and to also be indicated disabling of HARQ retransmissions for SPS PDSCH receptions by a DCI format activating the SPS PDSCH receptions for a SPS PDSCH configuration.

When a UE would provide HARQ-ACK information that is only in response to SPS PDSCH receptions for SPS PDSCH configurations with disabled HARQ retransmissions, a UE may not provide the HARQ-ACK information and may not transmit a corresponding PUCCH with the HARQ-ACK information.

One embodiment of the disclosure considers mechanisms to disable HARQ retransmissions for TBs provided by PUSCH transmissions scheduled by DCI formats.

When HARQ retransmissions for TBs provided by PUSCH transmissions are disabled for a UE, the UE does not start drx-RetransmissionTimerUL to receive PDCCHs for scheduling a HARQ retransmission of the TB in a PUSCH.

In a first approach, a HARQ retransmission enabling/disabling field of 1 bit can be included in a DCI format scheduling a PUSCH transmission providing a TB from a UE to indicate whether or not the UE should monitor PDCCH for detection of a DCI format scheduling PUSCH transmission with a HARQ retransmission of the TB. The field can be independently configured/included in some DCI formats scheduling PUSCH transmissions, such as a DCI format 1_1 or a DCI format 1_2 and not included in other DCI formats, such as DCI format 0_0.

In one approach, a UE can be indicated to monitor PDCCH for detection of a DCI format that does not include a redundancy version field. For a PUSCH transmission with a TB scheduled by the DCI format, the UE does not subsequently monitor PDCCH for detection of a DCI format scheduling PUSCH transmission with a HARQ retransmission of the TB. The DCI format may also schedule only an initial transmission for the TB and then the DCI format may not include a new data indicator (NDI) field.

In one approach, a DCI format scheduling a PUSCH transmission by a UE can indicate a first carrier/cell for a PUSCH transmission with an initial transmission of a TB and indicate a second carrier/cell for a PUSCH transmission with a HARQ retransmission of the TB. When a same HARQ process pool is not shared between the first and second carriers/cells, the DCI format can additionally include a field, such as a binary field in case of two carriers/cells, indicating whether the HARQ process associated with the TB is from HARQ processes used on the first carrier/cell or from HARQ processes used on the second carrier/cell. When a HARQ retransmission of a TB is via a PUSCH on a different carrier than an initial/previous transmission of the TB, the UE may be additionally configured, or it can be predetermined in the specifications of the system operation, whether the UE should monitor PDCCH for scheduling a PUSCH with HARQ retransmission of the TB as that may depend on the implementation of carrier aggregation for the first and second carriers/cells in the network.

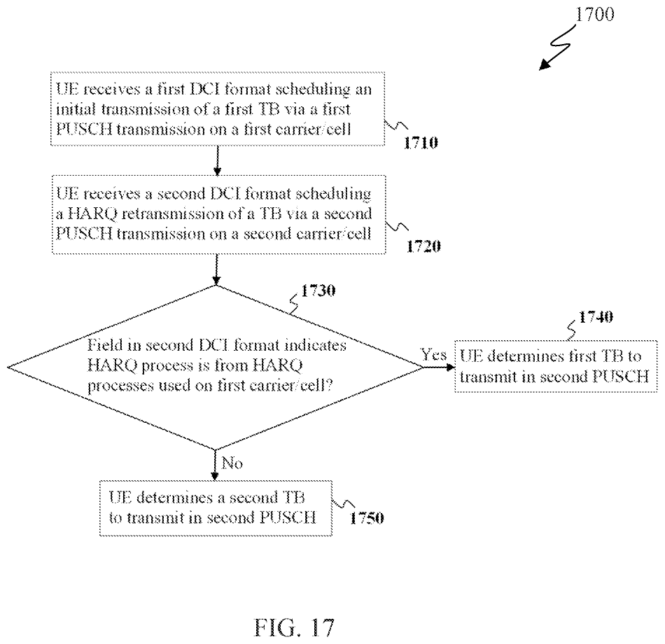

FIG. 17 illustrates an example method 1700 for a UE to transmit a first PUSCH with an initial transmission of the TB on a first carrier/cell and transmit a second PUSCH with a HARQ retransmission of the TB on a second carrier/cell according to embodiments of the present disclosure. The embodiment of the method 1700 for a UE to transmit a first PUSCH with an initial transmission of the TB on a first carrier/cell and transmit a second PUSCH with a HARQ retransmission of the TB on a second carrier/cell in FIG. 17 is for illustration only. FIG. 17 does not limit the scope of this disclosure to any particular implementation of the method 1700 for a UE to transmit a first PUSCH with an initial transmission of the TB on a first carrier/cell and transmit a second PUSCH with a HARQ retransmission of the TB on a second carrier/cell.

As illustrated in FIG. 17, the method begins at step 1710, where a UE (such as the UE 116) receives a first DCI format scheduling an initial transmission of a first TB via a first PUSCH transmission on a first carrier/cell. At step 1720, the UE receives a second DCI format scheduling a HARQ retransmission of a TB via a second PUSCH transmission on a second carrier/cell. At step 1730, the second DCI format includes a field indicating whether a HARQ process associated with the TB in the second PUSCH is from HARQ processes used on the first carrier/cell or from HARQ processes used on the second carrier/cell. The UE determines the first TB to transmit in the second PUSCH when the indication is for the first cell 1740; otherwise, the UE determines a second TB to transmit in the second PUSCH 1750.

In one embodiment, cell switching for CG-PUSCH transmissions is considered.

A serving gNB can indicate to a UE, for example as part of a CG-PUSCH configuration or by separate configuration/indication, two or more cells where the UE can transmit CG-PUSCH for the CG-PUSCH configuration. For example, the CG-PUSCH transmissions can be for pose/control information. For a first number of CG-PUSCH configurations, CG-PUSCH transmissions can be only on one cell and for a second number of CG-PUSCH configurations, CG-PUSCH transmissions can be on two or more cells. Cell switching for CG-PUSCH transmissions may be additionally conditioned on absence of HARQ retransmissions for the CG-PUSCH transmissions.

For example, for CG-PUSCH transmissions of a CG-PUSCH configuration that can be over two cells, a UE can be provided by a serving gNB via UE-specific RRC signaling a periodic cell switching pattern for CG-PUSCH transmissions. The cell switching pattern can be part of the CG-PUSCH configuration or can be separately indicated by RRC signaling. Each bit of the pattern corresponds to a slot for a reference SCS configuration as indicated by higher layers, with a value of ‘0’ or a value of ‘1’ indicating, respectively, the first cell or the second cell as the cell for CG-PUSCH transmissions during the slot of the reference SCS configuration. For example, the reference SCS configuration can be the one for an initial UL bandwidth part on the first cell. The UE does not transmit a CG-PUSCH for the CG-PUSCH configuration in a slot on a cell if the pattern indicates a different cell for the CG-PUSCH transmission during the slot. If a slot for the active UL BWP of the second cell overlaps with more than one slot on the active BWP of the first cell and the UE would transmit a CG-PUSCH on the second cell, the UE considers the first of the overlapping slots for the CG-PUSCH transmission on the second cell. The first of the overlapping slots may be additionally conditioned to be among overlapping slots where the UE can transmit the CG-PUSCH.

For determining a power for the CG-PUSCH transmission on the first cell or the second cell, a power control procedure described in TS 38.213 v 17.2.0 can apply per cell. For a closed loop power control (CLPC) component of the power control procedure, a DCI format 2_2 with CRC scrambled by a TPC-PUSCH-RNTI, as described in TS 38.212 v17.2.0, can include transmit power control (TPC) commands for both the first cell and the second cell for corresponding CG-PUSCH transmissions and the UE can be indicated by RRC signaling corresponding locations for the TPC commands in the DCI format 2_2.

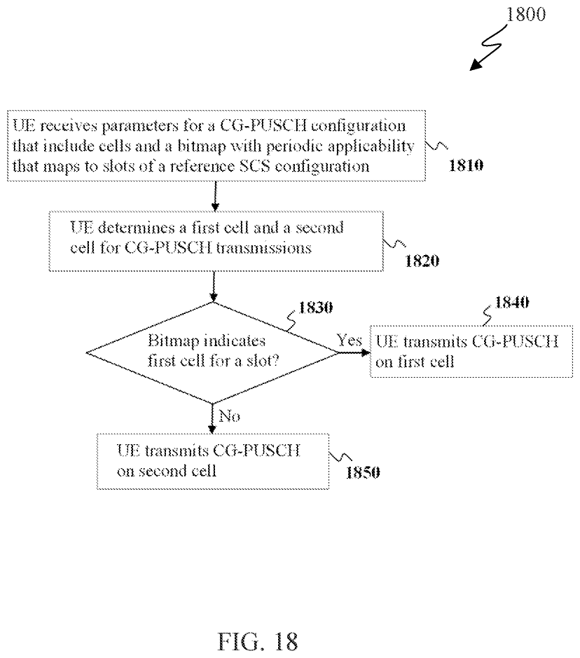

FIG. 18 illustrates an example method 1800 for a UE to switch cells for CG-PUSCH transmissions of a CG-PUSCH configuration according to embodiments of the present disclosure. The embodiment of the method 1800 for a UE to switch cells for CG-PUSCH transmissions of a CG-PUSCH configuration in FIG. 18 is for illustration only. FIG. 18 does not limit the scope of this disclosure to any particular implementation of the method 1800 for a UE to switch cells for CG-PUSCH transmissions of a CG-PUSCH configuration.

As illustrated in FIG. 18, a UE (such as the UE 116) receives parameters for a CG-PUSCH configuration that include cells for CG-PUSCH transmissions and a bitmap with periodic applicability that maps to slots corresponding to a reference SCS configuration. At step 1820, the UE determines a first cell and a second cell for CG-PUSCH transmissions. At step 1830, for a CG-PUSCH transmission during a slot, the UE determines whether the bitmap indicates the first cell for example when the corresponding value is ‘0’, or the second slot for example when the corresponding value is ‘1’. When the bitmap indicates the first cell, the UE transmits the CG-PUSCH on the first cell 1840; otherwise, the UE transmits the CG-PUSCH on the second cell 1850.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE), the method comprising:
receiving:
first information for a first configured grant (CG) configuration, and
second information for a second CG configuration;
determining:
based on the first information, that scheduling by downlink control information (DCI) formats for physical uplink shared channels (PUSCHs) with transport blocks (TBs) associated with the first CG configuration is enabled,
based on the second information, that scheduling by DCI formats for PUSCHs with TBs associated with the second CG configuration is disabled,
to start a timer after a first CG-PUSCH transmission with a first TB associated with the first CG configuration, and
to ignore the timer after a second CG-PUSCH transmission with a second TB associated with the second CG configuration; and
transmitting a first PUSCH with the first TB, wherein the first PUSCH is scheduled by a first DCI format.

2. The method of claim 1, further comprising:
receiving a physical downlink control channel (PDCCH) that provides a second DCI format, wherein:
the second DCI format activates CG-PUSCH transmissions associated with the first CG configuration,
the second DCI format provides an indication for whether or not to start the timer after a CG-PUSCH transmission, and
the indication is to start the timer.

3. The method of claim 1, wherein the first DCI format indicates termination of subsequent scheduling for PUSCH transmissions with the first TB.

4. The method of claim 1, wherein:
the second TB is associated with a hybrid automatic repeat request (HARQ) process, and
the second information indicates that scheduling by DCI formats for PUSCHs with TBs for the HARQ process is disabled.

5. The method of claim 1, further comprising:
receiving a physical downlink control channel (PDCCH) that provides a second DCI format, wherein the second DCI format indicates a duration for skipping PDCCH receptions scheduling PUSCH transmissions; and
suspending transmissions for a number of physical uplink control channels (PUCCHs) with channel state indication (CSI) reports within the duration.

6. The method of claim 1, further comprising:
receiving third information indicating:
a second cell for CG-PUSCH transmissions associated with the second CG configuration, wherein the second CG configuration is associated with a first cell; and
a bitmap providing a pattern over a number of slots, wherein a value of a bit in the bitmap indicates the first cell or the second cell for a corresponding slot;
determining a cell, from the first cell or the second cell, for a transmission of CG-PUSCH within the slot based on the value; and
transmitting the CG-PUSCH on the determined cell within the slot.

7. The method of claim 6, further comprising:
transmitting all CG-PUSCHs associated with the first CG configuration on the first cell.

8. A user equipment (UE), comprising:
a transceiver configured to receive:
first information for a first configured grant (CG) configuration, and
second information for a second CG configuration; and
a processor operably coupled to the transceiver, the processor configured to determine:
based on the first information, that scheduling by downlink control information (DCI) formats for physical uplink shared channels (PUSCHs) with transport blocks (TBs) associated with the first CG configuration is enabled,
based on the second information, that scheduling by DCI formats for PUSCHs with TBs associated with the second CG configuration is disabled,
to start a timer after a first CG-PUSCH transmission with a first TB associated with the first CG configuration, and
to ignore the timer after a second CG-PUSCH transmission with a second TB associated with the second CG configuration,
wherein the transceiver is further configured to transmit a first PUSCH with the first TB, wherein the first PUSCH is scheduled by a first DCI format.

9. The UE of claim 8, wherein:
the transceiver is further configured to receive a physical downlink control channel (PDCCH) that provides a second DCI format,
the second DCI format activates CG-PUSCH transmissions associated with the first CG configuration,
the second DCI format provides an indication for whether or not to start the timer after a CG-PUSCH transmission, and
the indication is to start the timer.

10. The UE of claim 8, wherein the first DCI format indicates termination of subsequent scheduling for PUSCH transmissions with the first TB.

11. The UE of claim 8, wherein:
the second TB is associated with a hybrid automatic repeat request (HARQ) process, and
the second information indicates that scheduling by DCI formats for PUSCHs with TBs for the HARQ process is disabled.

12. The UE of claim 8, wherein the transceiver is further configured to:
receive a physical downlink control channel (PDCCH) that provides a second DCI format, wherein the second DCI format indicates a duration for skipping PDCCH receptions scheduling PUSCH transmissions, and
suspend transmissions for a number of physical uplink control channels (PUCCHs) with channel state indication (CSI) reports within the duration.

13. The UE of claim 8, wherein:
the transceiver is further configured to receive third information indicating:
a second cell for CG-PUSCH transmissions associated with the second CG configuration, wherein the second CG configuration is associated with a first cell; and
a bitmap providing a pattern over a number of slots, wherein a value of a bit in the bitmap indicates the first cell or the second cell for a corresponding slot;
the processor is further configured to determine a cell, from the first cell or the second cell, for transmission of a CG-PUSCH within the slot based on the value; and
the transceiver is further configured to transmit the CG-PUSCH on the determined cell within the slot.

14. The UE of claim 13, wherein:
the transceiver is further configured to transmit all CG-PUSCHs associated with the first CG configuration on the first cell.

15. A base station, comprising:
a transceiver configured to transmit:
first information for a first configured grant (CG) configuration, and
second information for a second CG configuration;
a processor operably coupled to the transceiver, the processor configured to determine:
based on the first information, that scheduling by downlink control information (DCI) formats for physical uplink shared channels (PUSCHs) with transport blocks (TBs) associated with the first CG configuration is enabled,
based on the second information, that scheduling by DCI formats for PUSCHs with TBs associated with the second CG configuration is disabled,
to start a timer after a first CG-PUSCH transmission with a first TB associated with the first CG configuration, and
to ignore the timer after a second CG-PUSCH transmission with a second TB associated with the second CG configuration,
wherein the transceiver is further configured to receive a first PUSCH with the first TB, wherein the first PUSCH is scheduled by a first DCI format.

16. The base station of claim 15, wherein:
the transceiver is further configured to transmit a physical downlink control channel (PDCCH) that provides a second DCI format,
the second DCI format activates CG-PUSCH receptions associated with the first CG configuration,
the second DCI format provides an indication for whether or not to start the timer after the CG-PUSCH reception, and
the indication is to start the timer.

17. The base station of claim 15, wherein the first DCI format indicates termination of subsequent scheduling for PUSCH receptions with the first TB.

18. The base station of claim 15, wherein:
the second TB is associated with a hybrid automatic repeat request (HARQ) process, and
the second information indicates that scheduling by DCI formats for PUSCHs with TBs for the HARQ process is disabled.

19. The base station of claim 15, wherein the transceiver is further configured to:
transmit a physical downlink control channel (PDCCH) that provides a second DCI format, wherein the second DCI format indicates a duration for skipping PDCCH transmissions scheduling PUSCH receptions, and
suspend receptions for a number of physical uplink control channels (PUCCHs) with channel state indication (CSI) reports within the duration.

20. The base station of claim 15, wherein:
the transceiver is further configured to transmit third information indicating:
a second cell for CG-PUSCH receptions associated with the second CG configuration, wherein the second CG configuration is associated with a first cell; and
a bitmap providing a pattern over a number of slots, wherein a value of a bit in the bitmap indicates the first cell or the second cell for a corresponding slot;
the processor is further configured to determine a cell, from the first cell or the second cell, for reception of a CG-PUSCH within the slot based on the value; and
the transceiver is further configured to receive the CG-PUSCH on the determined cell within the slot.
